(19) United States
(12) Patent Application Publication
(10) Pub. No.: US 2014/0200863 A1
(43) Pub. Date: Jul. 17, 2014

(54) MONITORING PROXIMITY OF OBJECTS AT CONSTRUCTION JOBSITES VIA THREE-DIMENSIONAL VIRTUALITY IN REAL-TIME

(71) Applicant: The Regents of The University of Michigan, Ann Arbor, MI (US)

(72) Inventors: Vineet R. Kamat, Ann Arbor, MI (US); Sanat Talmaki, Peoria, IL (US)

(21) Appl. No.: 14/153,766

(22) Filed: Jan. 13, 2014

Related U.S. Application Data
(60) Provisional application No. 61/751,754, filed on Jan. 11, 2013.

(51) Int. Cl. G06F 17/50

(52) U.S. Cl. CPC G06F 17/50
USPC 703/1

(57) ABSTRACT

A method and system of monitoring proximity of objects at a construction jobsite via three-dimensional virtuality in real-time. The method and system involves simulating a dynamic object such as a piece of construction equipment in a three-dimensional virtual representation of the construction jobsite, and involves simulating another object such as a buried utility or another piece of construction equipment in the three-dimensional virtual representation of the construction jobsite. The method and system also involves making one or more determinations about the objects in order to more readily avoid unintended impact between them.

### CROSS-REFERENCE TO RELATED APPLICATION

This application claims the benefit of U.S. Provisional Application No. 61/751,754 filed Jan. 11, 2013, the entire contents of which are hereby incorporated by reference.

### GOVERNMENT LICENSE RIGHTS

This invention was made with government support under CMMI0825818, CMMI0927475, and CMMI1160937 awarded by the National Science Foundation and support under DTFH61-08-H-000035 awarded by the U.S. Department of Transportation. The government has certain rights in the invention.

### TECHNICAL FIELD

This disclosure relates generally to virtuality, and, in one context, relates particularly to ways of monitoring the proximity of construction equipment and buried utilities and other objects relative to each other in order to avoid unintended impact between them.

### BACKGROUND

Construction equipment is used in excavation, trenching, and drilling operations for laying, repairing, and in some cases replacing buried utilities. Buried utilities include the underground infrastructure found in industrial, urban, and rural areas like fluid and gas pipes and electrical cables. Still, construction equipment is used for other tasks. These activities sometimes present the uncertainty of unintended impact between equipment end-effectors (e.g., excavator buckets) and the buried utilities, as well as unintended impact between other objects. It has been estimated that there are nearly 500,000 utility impacts per year in the United States alone. Other activities involve autonomous, semi-autonomous, and remote machine control which may present an even greater uncertainty of impact with buried utilities and, moreover, impact with objects above ground.

To date, construction equipment operators and jobsite workers have relied on experiential judgment in order to avoid these kinds of impacts, and have relied on ground flags, stakes, and spray paint to mark buried utilities. Technology-based approaches have involved video cameras mounted on construction equipment like a back-up camera or side-facing camera. Yet more advanced approaches have involved augmented reality in which virtual representations of buried utilities are superimposed over a real-world view of the construction jobsite. Still, the approaches fall short in many ways and impact events occur with regrettable frequency.

### SUMMARY

According to one embodiment, a method of monitoring proximity of objects at a construction jobsite via three-dimensional virtuality in real-time includes several steps. One step involves simulating movement of a dynamic object of the construction jobsite in a three-dimensional virtual representation of the construction jobsite. Another step involves simulating a second object of the construction jobsite in the three-dimensional virtual representation of the construction jobsite. Yet another step involves determining a geometric proximity between the simulated dynamic object of the construction jobsite and the simulated second object of the construction jobsite. And another step involves outputting a notification based upon the geometric proximity determination.

According to another embodiment, a system for monitoring proximity of objects at a construction jobsite via three-dimensional virtuality in real-time includes a computer readable medium with a non-transient data storage device having instructions thereon for performing several steps. One step involves simulating a terrain of the construction jobsite in a three-dimensional virtual representation of the construction jobsite. Another step involves simulating movement of a dynamic object of the construction jobsite with respect to the simulated terrain in the three-dimensional virtual representation of the construction jobsite, the simulation involving receiving movement data from at least one device of the dynamic object. Another step involves simulating a static object of the construction jobsite with respect to the simulated terrain in the three-dimensional virtual representation of the construction jobsite, the simulation involving georeferencing. Another step involves determining a geometric proximity between the simulated dynamic object of the construction jobsite and the simulated static object of the construction jobsite. Another step involves displaying the three-dimensional virtual representation of the construction jobsite with the simulated terrain, with the simulated dynamic object, and with the simulated static object. And yet another step involves outputting a notification based upon the geometric proximity determination.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a diagrammatic representation of one embodiment of a visualization framework that is used in a method and system of monitoring proximity of objects at construction jobsites;

FIG. 2 is a diagrammatic representation of an excavator object scene graph with transformation nodes;

FIG. 3 is a diagrammatic representation of an excavator equipped with orientation sensors and position sensors;

FIG. 4 is a diagrammatic representation showing real-world sensor data for construction equipment updating hybrid virtual world computer-aided design (CAD) objects;

FIG. 5 is a diagrammatic representation of different bounding volume types;

FIG. 6 is a diagrammatic representation of different sphere swept volumes;

FIG. 7 is a diagrammatic representation of a system for creating hybrid virtuality (HV) simulations;

FIG. 8 is a diagrammatic representation of a scene graph of an HV scene for an excavation construction jobsite;

FIG. 9 depicts output from an HV simulation in sequence;

FIG. 10 is a diagrammatic representation of user-interactivity functionalities in visualization;

FIG. 11 is a flow diagram showing examples of the types of three-dimensional (3D) geometric models;

FIG. 12 is a diagrammatic representation of data collection, archival, and visualization;

FIG. 13 is a diagrammatic representation of an end-effector position-orientation computation through sensor fusion and real-time computation;

FIG. 14 is a flowchart of an example distance query;

FIG. 15 is a flowchart of an example collision query;

FIG. 16 diagrammatically illustrates the use of separating axis to determine overlap between oriented bounding boxes;

FIG. 17 diagrammatically illustrates the use of external Voronoi regions to determine configuration of a pair of edges;

FIG. 18 is a diagrammatic representation of one embodiment of the overall method and system of monitoring proximity of objects at construction jobsites;

FIG. 19 is a graph of separation distance error as a function of separation distance;

FIG. 20 is a diagrammatic representation of an embodiment of methodology for creating a link between real-world sensor data and 3D virtual construction equipment models; and

FIG. 21 is a diagrammatic representation of a framework for integration with real-time 3D visualization and geometric proximity monitoring.

### DETAILED DESCRIPTION OF THE PREFERRED EMBODIMENTS

The present disclosure provides embodiments of methods and systems for monitoring proximity of objects at a construction jobsite via three-dimensional virtuality in real-time. In general, the methods and systems provide improved visibility guidance and spatial awareness for construction equipment operators and jobsite workers so that unintended impacts between objects on construction jobsites can be more readily avoided. As used herein, the term “object(s)” encompasses both dynamic and static objects typically found on a construction jobsite such as construction equipment, buried utilities, building structures, and workers. And the term “construction equipment” encompasses excavators, backhoe loaders, dump trucks, compact loaders, draglines, mining shovels, off-highway trucks, material handlers, cranes, as well as other machines.

In general, the method and system detailed in this description includes several frameworks that can be implemented in a computer program product and/or a controller having instructions embodied in a computer readable medium with a non-transient data storage device. Further, the frameworks can utilize various algorithms, models, formulae, representations, and other functionality. The computer program product and/or controller can have hardware, software, firmware, or other like components configured and programmed to perform the steps, and can employ memory components, processing components, logic components, lookup tables, routines, modules, data structures, or other like components. Still further, the computer program and/or controller can be provided with instructions in source code, object code, executable codes, or other formats. One specific example of a programming language that may be employed is the C++ programming language. Moreover, while this description details examples of algorithms, models, formulae, and representations, skilled artisans will appreciate that other algorithms, models, formulae, and representations may be used as suitable alternatives. The computer program product and/or controller may be one or more discrete component(s) or may be integrated into, for example, a piece of construction equipment or another construction jobsite machine.

The methods and systems detailed in this description are set forth in different computational frameworks or modules. Each framework provides a functionality that, taken collectively, monitor the proximity of objects at construction jobsites in real-time and in three-dimensions. Each framework functions generically and can be altered for specific applications apart from those detailed in this description. In one embodiment, the method and system includes four general frameworks: a visualization framework, a geospatial data analysis framework, a geometric proximity monitoring framework, and a construction equipment articulation tracking framework.

### Visualization Framework

In general, the visualization framework is designed to represent a real-world operation in a virtual 3D scene by integrating dynamic 3D models, real-world position and orientation (pose) data, and georeferenced static 3D models. As with the other frameworks, the visualization framework is scalable for use in construction operations that involve static and dynamic objects. The visualization framework presents a “hybrid virtuality” (HV) in the sense that the represented scene includes 3D models of real-world objects that, in some embodiments, rely on tracking information from sensors installed on the real-world objects (e.g., sensors on the construction equipment). The resulting HV simulation can also utilize user input from the real-world to update virtual objects in the scene.

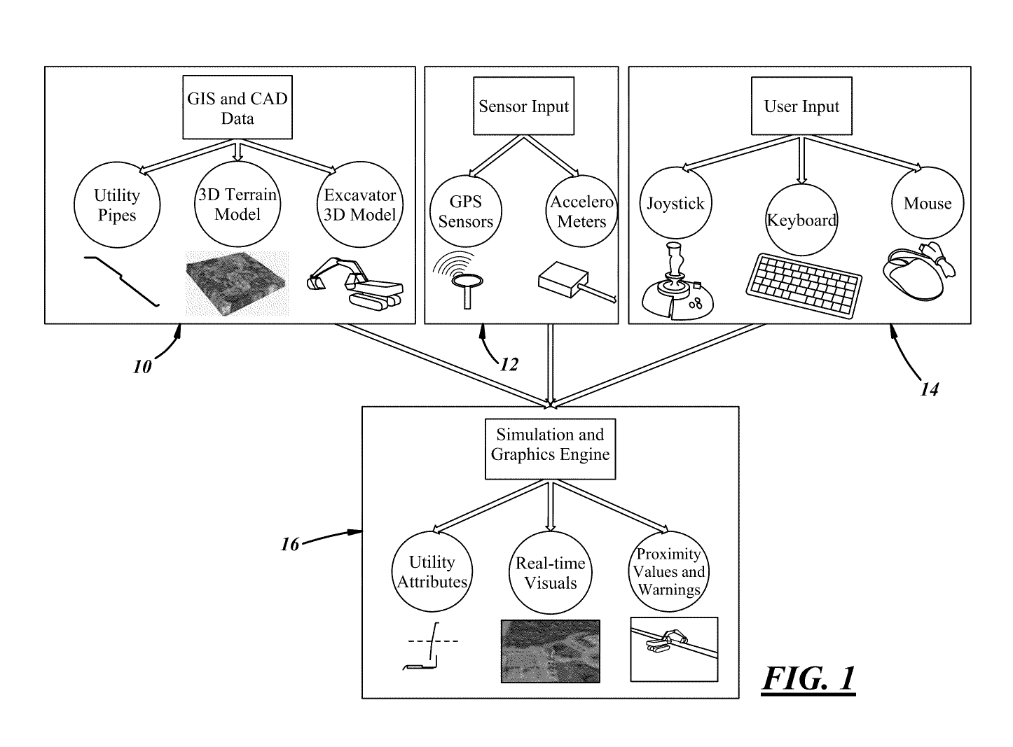

FIG. 1 represents the visualization framework and its data flow for an example excavation jobsite. In this embodiment the visualization framework includes geographical information system (GIS) and computer-aided design (CAD) data 10, sensor input 12, user input 14, and a simulation and graphics engine (SAGE) 16. As depicted in FIG. 1, the GIS and CAD data 10, sensor input 12, and user input 14 are introduced into the simulation and graphics engine 16. The simulation and graphics engine 16 outputs buried utility attribute details of GIS and CAD models, real-time visuals showing the represented construction jobsite, and proximity values and warnings among the objects present in the HV simulation. Since the sensor and user input 12, 14 update the GIS and CAD data 10 in the simulation and graphics engine 16 in real-time, the HV simulation gives warnings if a pair of objects come within a pre-determined safety threshold.

In general, the GIS and CAD data 10 are used to represent a typical construction jobsite. The data 10 includes buried utility data, temporary structure data, semi-completed structure data, and construction equipment data, among other data. In some instances it is preferable in a 3D scene to provide a balance between the level of realism and its affect on real-time performance. The balance can be satisfied by creating 3D models of buildings and buried utilities in wireframe and textured with digital images. But if real-time performance is unaffected, these measures in the 3D models may be unnecessary.

As used herein, the phrase “level of world representation” (LWR) describes the number of models and their respective level of detail in an HV scene. If an HV scene contains all surface and sub-surface objects in the real-world, it has an LWR of one-hundred percent (100%). The LWR may largely depend on the type of construction operation represented and the objective of the HV simulation. Table 1 set forth below is an eight parameter LWR index that categorizes HV scenes into different levels of detail ratings. In other embodiments, the number of models and level of detail in an HV scene can be captured in other ways.

TABLE 1

| Parameter # | Feature | State | Origin | Example |
|---|---|---|---|---|
| 1 | Surface | Static | Human-made | Buildings, |
| | | | | temporary |
| | | | | structures |
| 2 | Surface | Static | Natural | Trees, rivers, |
| | | | | lakes, soil, rocks |
| 3 | Surface | Dynamic | Human-made | Equipment |
| | | | | personnel |
| 4 | Sub-surface | Static | Human-made | Utility pipes, |
| | | | | conduits, cables |
| 5 | Airborne | Dynamic | Human-made | Airplanes, UAVs |
| 6 | Sub-surface | Static | Natural | Bedrock, ground |
| | | | | water, sub-surface |
| | | | | soil |
| 7 | Atmosphere | Static + | Natural | Rain, clouds, fog |
| | | Dynamic | | |
| 8 | Terrain | Static | Natural | Surface undulation |

In the table, parameter 1 includes surface structures such as buildings, temporary structures, sidewalks, as well as other similar objects. Parameter 2 includes natural features such as trees, rivers, lakes, soil, earth, and surface soil. Parameter 3 includes equipment and personnel present at the construction jobsite. Parameter 4 includes underground infrastructure like buried utilities, conduits, and transformer boxes. Parameter 5 includes airborne objects such as airplanes and helicopters. Parameter 6 includes naturally occurring subsurface features like bedrock, gravel, earth, and underground water. Parameter 7 includes natural atmosphere features such as clouds, rain, and fog. And parameter 8 includes terrain features like elevation details and surface imagery.

It has been found that, with the eight parameters, an HV scene modeler can determine the LWR based on objectives and output. For instance, in an excavation operation, the objective is to help operators avoid impacting buried utilities. In this HV simulation then, parameters 3, 4, and 8 could be modeled in the HV scene. This would yield a ⅜ LWR index score, or a thirty-eight percent (38%) LWR. A one-hundred percent LWR, while a possibility, need not necessarily be sought in this excavation example.

The GIS data of the GIS and CAD data 10 can be used to represent building footprint areas, lot boundaries, buried utilities, as well as other features in the HV simulation. The GIS data generally consists of two data parts: a geometry part and an associated attribute part. Currently, the GIS data is stored in a single object relational database management system (DBMS). The GIS data is then accessed via a front-end GIS application. The DBMS model permits ready access to the data and the creation of 3D models of the geometry part of the GIS data. The geometry part is typically in a two-dimensional (2D) form as points, lines, or polygons. Creating the 3D models from the 2D geometry can ensure that the 3D models have the same spatial attribute and real-world location as the underlying 2D geometry.

Since GIS data represents features on the earth's surface, their locations in a GIS dataset correspond to the earth's coordinates at the locations—that is, latitude and longitude values. This is referred to as a coordinate system and in the case of the earth is called a geographic coordinate system (GCS). In general, a coordinate system is any fixed reference framework superimposed onto a surface in order to designate the location of features on or within it. While a GCS represents the earth as a 3D spheroid, some applications and maps represent the earth as a 2D plane. In order to do so, a projected coordinate system (PCS) is derived from the GCS. The PCS uses linear units of measurement for coordinates rather than the latitude and longitude values, and hence distance and area calculations can be performed in linear units. The conversion from 3D to 2D can be achieved by projecting the 3D spheroid onto a 2D plane using a map projection. Distortions in shape, distance, and area may occur. There are several PCSs, like the Universal Transverse Mercator and the State Plane Coordinate System, with each PCS suited for a certain region of the earth. The different PCSs may have different units and datum. Because of this, two dissimilar datasets may have to be re-projected to a common PCS. And unlike PCS, GCS can identify the positions of objects anywhere on the earth's surface using only latitude and longitude values. Thus the HV simulation accepts input in the form of latitude and longitude values, which is internally converted by the visualization framework to the appropriate PCS. This helps ensure uniformity of input and accuracy of output. The PCS is suitable for the HV simulation detailed in this description.

The CAD data of the GIS and CAD data 10 includes all of the 3D objects that are not part of the GIS data, such as equipment, personnel, buildings, and other temporary structures present at a construction jobsite. Three-dimensional objects can be represented as points, lines, surfaces, or procedural techniques. Points, for instance, are somewhat commonly used in computer vision technologies where 3D objects are often created rapidly using an input of point cloud data. Traditionally, in 3D simulations, objects are represented through surfaces and sometimes through solids. In surface representation, the 3D object's surface is made up of polygons like triangles and quadrangles. The polygons are bound together to form a polygonal mesh. In HV simulations, CAD objects are used as input for proximity computations and impact detection queries. And the 3D surface models can be input for these computations and can therefore be used for representing 3D geometry.

Within an HV scene, a 3D object can appear as a simple individual entity. But complex 3D objects can be made of multiple constituent objects. An excavator, for example, conventionally includes a cabin, a boom, a stick, and a bucket. The cabin houses the excavator's controls and seats an operator. The boom is pivotally hinged to the cabin, and the stick is in turn pivotally hinged to the boom. Likewise, the bucket is pivotally hinged to the stick and is the component of the excavator that digs into the ground and sets removed earth aside. The components and their pivotal hinges in the excavator can be described by a parent-child relationship where the cabin is the parent of the child boom, while the boom is the parent of the child stick. Likewise, the bucket is the child of the stick, but is not itself a parent. The parent-child relationship can represent the behavior of objects in the real-world that have linkages in them. The human body is another example of a 3D object with linked parts that can be represented via a parent-child relationship. When the parent translates or rotates, all of its child objects also translate and rotate to the same extent. On the contrary, when a child translates or rotates, its parent does not necessarily translate and rotate as a result. In the excavator example then, when the cabin moves, all of the boom, stick, and bucket move with the cabin; but when the bucket is pivoted about its hinge relative to the stick, only the bucket moves and none of its parents move.

In general, the sensor input 12 depends on the exact piece of construction equipment used and the task being carried out. Examples of sensors employed on construction jobsites include global positioning system (GPS) tracking sensors and sensors equipped to the construction equipment such as strain gauges and accelerometers. When used, for instance, a GPS tracking sensor can record the translation motion of a construction jobsite dump truck. In this way, the sensors can be used to update the pose of objects present in the HV scene. Other types of sensors than those specified here can be used in the visualization framework. The sensor input 12 could also assist accident investigation as the input's data stream could be logged for replaying mishap events via the HV simulation.

In general, the user input 14 comes from human interface devices (HIDs) such as joysticks, keyboards, and mouses. Joysticks, in particular, and similar devices are employed in teleoperating and mobile remote robotics for controlling machines at remote locations and could be employed on construction jobsites. The user input 14 can be used to, for example, display on-demand information like buried utility attributes, for altering a transparency level of 3D models like terrain, and for altering the user's viewing position within the HV simulation. Furthermore, in some cases, the user input 14 can be used in combination with, or as a replacement for, sensor input to provide commands in order to update the pose of construction equipment in the HV scene for set-up purposes. The user input 14 also updates and advances the HV scene, in particular the 3D models of the construction equipment. When a construction jobsite event such as an accident is replayed, however, the user input 14 need not be used for the HV simulation; in this case, the sensor input 12 data is used.

In general, the simulation and graphics engine 16 renders the HV scene of the construction jobsite. It also displays warnings when the proximity between a pair of objects (e.g., excavator bucket and buried utility) is within a pre-determined safety threshold. Further, the simulation and graphics engine 16 provides the construction equipment operator with information such as detail of a utility line that may not otherwise be evident when viewed in the real-world.

The SAGE 16 receives three things: i) the user input 14 from the human interface devices completing the simulation loop, ii) the sensor input 12 from sensors located on construction equipment, personnel, and structures, and iii) 3D models representing the GIS and CAD data 10 for other objects present at the construction jobsite. Functions of the SAGE 16 include providing real-time rendering of the HV scene, and processing the multi-source data input in order to compute the proximities between a pair of objects present in the HV simulation. The SAGE 16 may also provide warnings that arise out of proximity computations, and may present on-demand attribute display of HV scene objects. The objects in an HV scene can be stored in a hierarchical manner that represents their real-world relationships to one another and also leads to efficiency in HV scene rendering. To accomplish these things, in one embodiment the SAGE 16 implements scene graph structure as a general data structure.

Generally, scene graphs have a hierarchical tree structure for managing transformations, level of detail, field-of-view culling, and animation. Scene graph implementations are based on lower-level graphics application programming interfaces (API) such as OpenGL. Scene graphs may offer a higher-level interface and commands for applications compared to directly using a graphics API. In essence, scene graphs form another layer of abstraction between the graphics hardware and the application. The scene graph data structure consists of nodes of differing nature. Nodes can be used to store the polygon geometry of 3D objects, apply translation and rotation to objects, serve as parent nodes for a group of child nodes, hide and show other nodes, as well as other uses. The node at the top of the scene graph is customarily referred to as the root node. All of the constituent elements of the scene are child nodes of the root node.

The nodes also have a parent-child relationship that can be used to model the 3D object having pivotal hinges and linkages, as previously described. Due to their hierarchical nature, scene graph structures allow an entire sub-graph of the overall scene graph from being rendered, thus reducing computational burden. Scene graphs' ordering and classification of nodes also give the simulation user the option of viewing only certain types of nodes that are of interest at a given instant. Scene graph structures are not necessarily limited in their suitability to the run-time aspect of HV simulations. Their structure is also suitable for articulated object and HV scene creation.

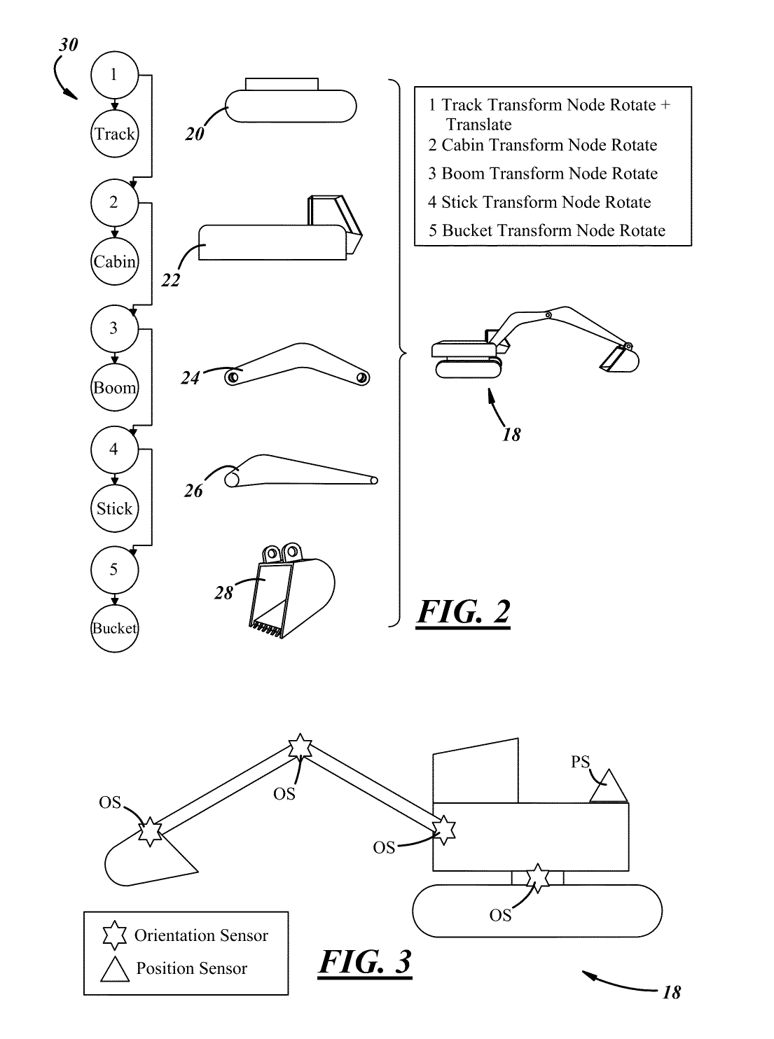

For example, a scene modeler for the excavator 18 of FIG. 2 may generally add parent and child nodes in any order to existing nodes. The scene graph structure permits nodes to be added above (i.e., parent) and below (i.e., child) a given node in its hierarchy. The object nodes forming an articulated object like that of the excavator 18 may translate, rotate, or translate and rotate. Transformation nodes can be used to specify direction and magnitude of rotation and translation of an articulated object's node, as shown in FIG. 2. When creating the excavator 18 as an object, a track 20 object should translate and rotate in order to replicate an excavator's track in the real-world. When the track node (transform) is rotated, all of its child nodes—cabin 22, boom 24, stick 26, and bucket 28—also rotate by the same amount. This is depicted in FIG. 2 by flow diagram 30. New scene graphs can be created by combining two or more existing graphs; that is, by adding other scene graphs as child nodes. This enables the creation of a new HV scene from existing scene graph elements.

A scene consisting of a dump truck and the excavator 18 on a construction jobsite with buried utilities is an example of a typical scene that can be modeled as an HV simulation. In this example, the SAGE 16 receives input in the form of the 3D terrain model of the construction jobsite. The GIS data input for the buried utility and CAD data input for articulated objects represents the dump truck and the excavator 18. The articulated dump truck and excavator 18 are scene graphs that can be added to the parent scene graph representing the HV scene.

For the output of an HV simulation to be useful in some cases, all of the objects present in the simulation can be calibrated to represent their pose in the real-world at the start of the simulation. Without this, the HV simulation may not be an emulation of the real-world construction jobsite. This may be particularly true of articulated construction equipment because of its dynamic nature. The CAD equipment models loaded into the SAGE 16 are updated with pose data from the construction jobsite to specify their pose. The task has been successfully included as part of the initialization process of a visual simulation framework in the past. After the initialization step, the equipment CAD models have poses equivalent to their real-world counterparts.

The transmission of pose data from the construction equipment to the SAGE 16 can be carried out via sensors and wireless data transmission. Other means of data transmission may be possible. Orientation sensors can be placed at hinge and joint locations in the construction equipment that will rotate during operation. Position sensors can be placed on the construction equipment body to update position in the HV simulation. FIG. 3 shows the excavator 18 equipped with orientation sensors (OS) at its hinges and a position sensor (PS) at its cabin, as one example.

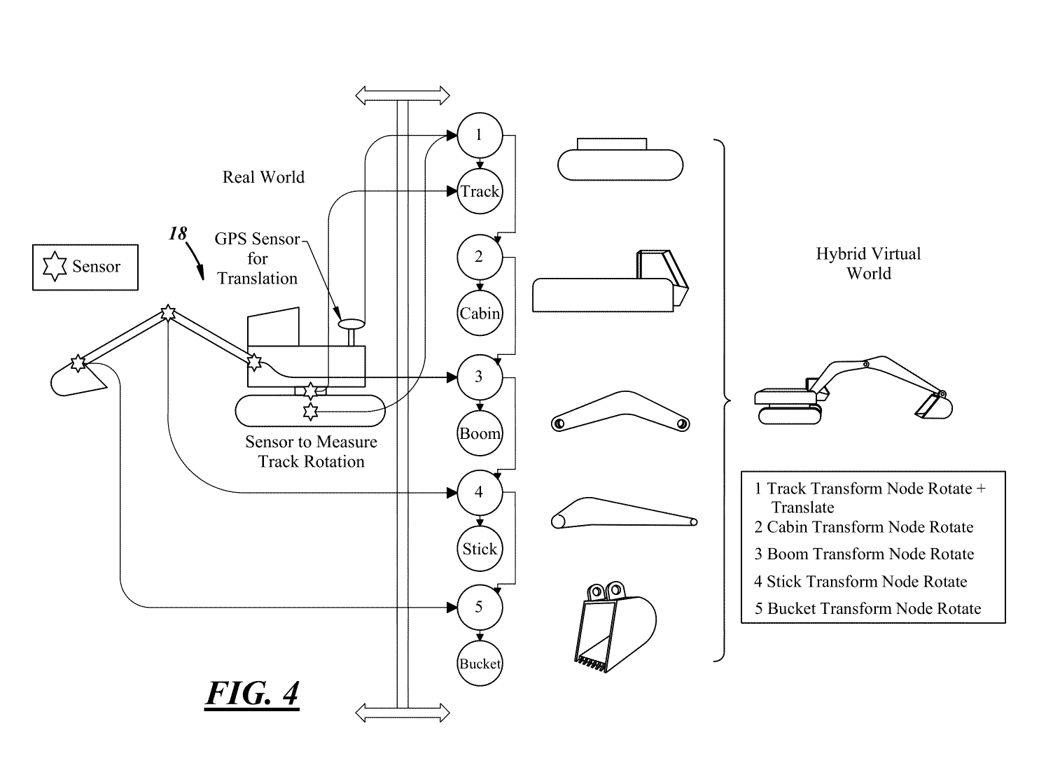

The virtual CAD object representing the real-world excavator can consist of multiple nodes, each having its own transform node as previously shown in FIG. 2. Each sensor on real-world construction equipment updates its corresponding transform in the HV simulation's virtual equipment model. This arrangement helps ensure that every virtual CAD equipment object is an up-to-date representation of the real-world construction equipment. FIG. 4 is a diagrammatic portrayal of this relationship, using the excavator 18 example. Consequently, the warnings from proximity queries and collision detection computations can be accurate.

In one embodiment, the GIS and CAD data 10 provided as input to the SAGE 16 are polygon meshes. Their entire surface can be described by a collection of numerous polygons or geometric primitives. The polygons can be either triangles or quads. The polygons do not necessarily have any topological relationship with their neighboring polygons, and the collection of polygons is sometimes referred to as a polygon soup. In one example, the excavator 18 model consists of four-thousand-nine-hundred-and-eighty-two polygons. A collision occurs when polygons belonging to two discrete objects overlap or come into contact with each other. Similarly, a proximity query gives the minimum Euclidean distance between the set of polygons belonging to a pair of objects.

Simulation environments with proximity information and collision detection can generally exhibit four characteristics. First, models have high complexity and are typically composed of hundreds of thousands of polygons that together describe the surface of the model. Second, the model's collection of polygons usually has no topology information and is considered to be a polygon soup. Third, a pair of models can be in close proximity to each other and share more than a single collision or contact point. Fourth, dynamic visual simulations sometimes call for accurate output for the proximity and contact between a pair of models.

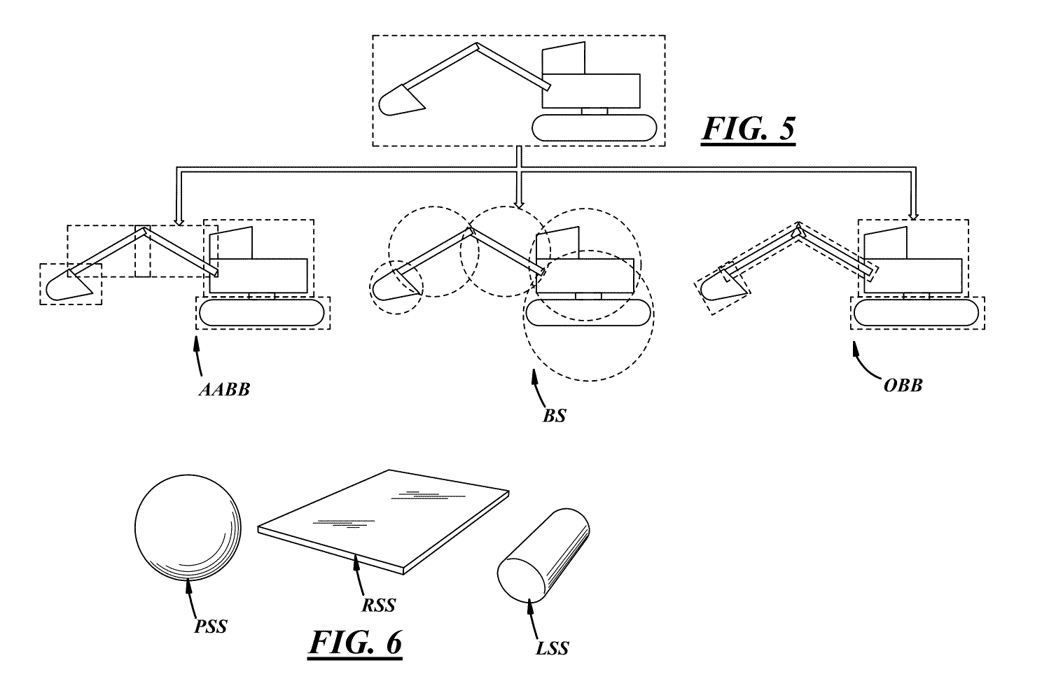

Hybrid virtuality simulations can exhibit all four of these characteristics, which can call for a collision detection mechanism that can process data in real-time and that can handle large and complex data sets. As the complexity and size of 3D models increase, so typically do their number of geometric primitives. It is generally difficult for a collision detection algorithm to check for the overlap of every primitive making up a 3D model and still have an interactive, real-time performance. To reduce the number of computations, some algorithms use a concept known as a bounding volume. A bounding volume is created such that it envelops the entire 3D model and all of its primitives. The 3D model is then recursively subdivided into smaller bounding volumes—this is depicted in FIG. 5. The subdivision of a model into smaller volumes can be done in different ways. For instance, the volumes can be constructed as axis-aligned bounding boxes (AABB in FIG. 5), bounding spheres (BS), or oriented bounding boxes (OBB). The OBB technique has been shown to be efficient at reducing computation time for scenarios involving large models in relatively close proximity, but the other techniques AABB and BS may be suitable in some embodiments. The bounding boxes of OBB form a tree structure, referred to as an OBBTree. The subdivision of 3D models can continue until the bounding volumes are enveloping individual geometric primitives which can no longer be subdivided.

In one embodiment, in order to determine if a pair of 3D models is colliding, their bounding boxes are checked for overlap. If the bounding boxes have no overlap, further computations may be unnecessary. Thus, here, it is a two phase approach for determining collisions between models. The two phase approach may save computation time compared to a single phase approach, especially when a pair of CAD models is distant and the possibility of collision is minimal. If an overlap is found, the next levels of bounding boxes along the OBBTree are checked for overlap. This is done recursively until the bounding boxes at a particular level do not overlap. When an overlap is found, the detailed computationally intensive test checks for intersections of geometry primitives. This test confirms if a pair of 3D CAD models is colliding and also gives the details, such as the pair of primitives that are involved in the collision.

Proximity queries compute the minimum distance between a pair of 3D CAD models. These queries are similar to collision queries. As the calculation proceeds, the smallest distance between a pair of primitives can be stored in memory. The distance value can be initialized to a large value when the query begins. At the end of the query, if this value is found to be zero, the implication is that the objects are colliding. A category of bounding volumes called sphere swept volumes (SSVs) can in some cases give improved performance compared to OBB volumes for proximity queries. In general, SSVs consist of the core primitive shape that is grown outward by some offset. The offset is referred to as radius. The shape corresponds to that created by a sphere whose center is moved over all of the points of the core geometric primitive points.

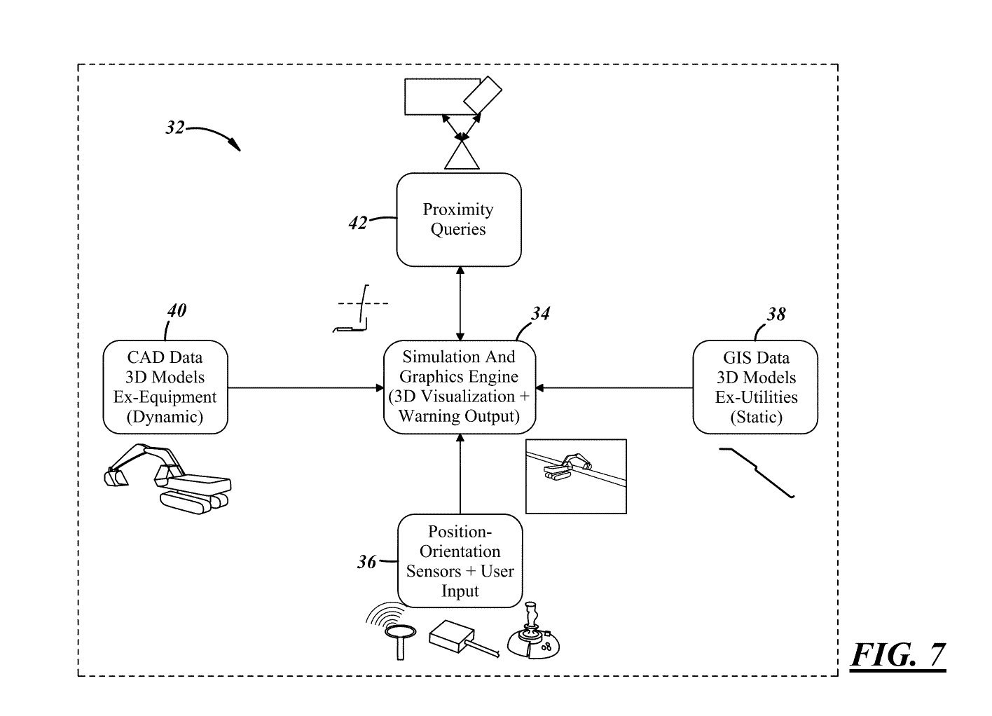

Referring now to FIG. 6, based on the shape of the underlying geometry, the SSV can be a point swept sphere (PSS), a line swept sphere (LSS), or a rectangle swept sphere (RSS). The bounding volume hierarchy can be made up of a tree of SSVs. The tree can consist of a combination of PSS, RSS, or LSS, as determined by the underlying geometry. Here, the proximity query is performed by computing the distance between the primitive core shapes, and subtracting the offset radius of each bounding volume.

FIG. 7 depicts an embodiment of a system 32 designed to allow users to create HV simulations that emulate real-world construction jobsites and operations. The system 32 is sometimes referred to as SeePlusPlus in this description. Hybrid virtuality scenes can be created using existing sub-graphs of articulated construction equipment, terrain, and buried utilities. In this embodiment, the system 32 includes a simulation and graphics engine 34, sensor and user input 36, GIS data 38, CAD data 40, and proximity queries 42. The system 32 has been designed using open scene graph (OSG) as its scene graph component of the SAGE 16, but could be designed in other ways in other embodiments. Generally, OSG is an open-source, cross-platform graphics toolkit based on the OpenGL graphics library. Here, OSG is implemented in standard C++ programming language. In addition to the core functionality of a scene graph, OSG has numerous plug-ins that read/write the most commonly used 2D image and 3D model formats. OSG plug-ins can load 2D file formats such as jpeg, png, bmp, and tiff, and 3D model formats such as 3ds, ac, and lwo, among others. OSG's native file format for scene graphs is eponymous and is in human-readable ASCII format, making it suitable for debugging purposes. Runtime applications can use faster binary file formats, such as osgb and ive. The SAGE 16 may be designed to allow the use of both ASCII and binary-based files within the same scene graph. OSG can work with a variety of windowing toolkits, such as Microsoft foundation classes (MFC), Qt, and fast and light toolkit (FLTK). Qt is used as the windowing toolkit for the system 32 in one embodiment due to its platform-independence, but other windowing toolkits may be suitable in other embodiments.

The system 32 allows users to create articulated objects using individual components. The user can create parent-child hierarchies and use transform nodes to effect rotation and translation. The OSG framework consists of two transform node types, namely matrix transform (MT) and position attitude transform (PAT) nodes. Transform nodes can have one or more child nodes and can be used as transform nodes for articulated object creation. While creating an object, the user can assign rotation, translation, or both rotation and translation to a transform node based on the attributes of a given component. For example, the boom 24's transform node in the excavator 18 example can be given only rotation since it typically does not translate during operation, unlike the cabin 22 which can rotate and translate.

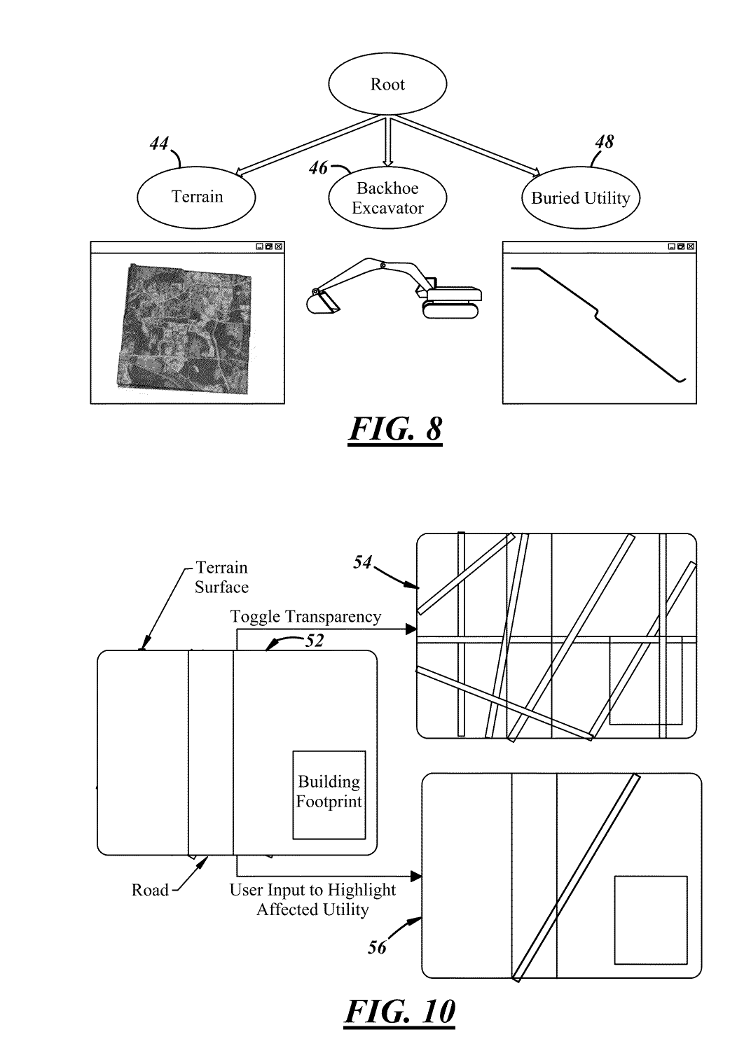

An HV scene is the aggregation of all articulated object construction equipment, 3D terrain, and GIS and CAD data that are part of the real-world being emulated by the HV scene. Hence a complete HV scene is a scene graph that uses existing sub-graphs of articulated objects and other 3D objects set in hierarchical order. The top-most node of the HV scene is customarily referred to as the root node. FIG. 8 represents an HV scene emulating an example excavation construction jobsite and has sub-graphs for terrain 44, articulated excavator object (backhoe excavator) 46, and 3D models of a buried utility 48. The input options for articulated objects, such as the backhoe excavator 46, can be specified at the time of HV scene creation.

The 3D terrain model is similar to the other 3D objects in the HV scene, in that it can be made up of geometric primitives such as triangles and quads. Three dimensional terrain models use elevation data and a georeferenced image of the terrain. Elevation data is typically stored in a raster format and is a digital representation of the elevation of the terrain. One common format for representing terrain elevation is a digital elevation model (DEM). A DEM refers to a regular grid (raster) of spot heights. Digital elevation models are essentially a sampled array of elevations for the ground position at regularly spaced intervals. The interval spacing defines the resolution of a particular DEM. A smaller-spaced, higher-resolution DEM may result in a more accurate terrain model. Digital elevation models are available from a number of sources, such as the United States Geological Survey (USGS) for the U.S. Other sources may be available for other countries, territories, and areas. The USGS is a repository for elevation data, referred to as the national elevation dataset (NED). The accuracy of the data in the NED can range from 30 meters to 3 meters for the conterminous United States.

A georeferenced image may also be used for a 3D terrain model. The elevation data and georeferenced image may suitably have the same datum, projection coordinate system, and units for them to coincide. As examples, virtual planet builder (VPB) and osgEarth are two commonly used 3D terrain creation toolkits. Both of these toolkits have been successfully used to create 3D terrains for SeePlusPlus; other terrain creation toolkits may be suitable. Virtual planet builder can create a 3D terrain model file that is stored in memory. This file is a sub-graph that can be added to the HV scene when created. OsgEarth, on the other hand, uses an extensible markup language (XML) file to reference the elevation and image data. The terrain is rendered at runtime and, unlike VPB, the 3D terrain file is not physically present on the hard disk. Both toolkits are based upon the OSG framework and thus seamlessly integrate with any OSG-based application such as SeePlusPlus. The elevation data is processed by the terrain-creating algorithm that creates a 3D mesh representing the real-world terrain using the spot heights from the DEM. The polygon mesh is then draped with the georeferenced image of the terrain to give a complete 3D terrain.

Preventing unintended impacts between excavators, for example, and buried utilities can in some cases rely on the accuracy of 3D models of the buried utilities. The proximity queries and collision detection computations can be performed by algorithms using 3D objects. The buried utility data is typically stored in the GIS databases of utility service companies and providers. In some cities and countries, the data for all buried utilities is stored in a single database. The data for utility lines such as pipes and conduits can be in the form of lines and polylines. This 2D data may not necessarily be representative of the buried utilities in the real-world. Moreover, the data may not be suitable in some collision detection and proximity computations due to the lack of geometric primitives such as triangles and quads. Thus, in some instances, the data from GIS databases or CAD drawings can be processed to create accurate 3D models.

The GIS data exhibits a georeferenced property, which is suitable in some embodiments. Generally, georeferencing is the assignment of a location attribute to information. Georeferencing is done through systems such as latitude-longitude, projection coordinate systems, and global positioning systems. Suitably, all of the information being used in an HV simulation can be the same projected coordinate system and can have the same units. Any data having dissimilar georeferencing may not coincide with the rest of the elements in an HV simulation. Thus, in one embodiment, the utility data from a given database should have the same datum, projection coordinate system, and units as the terrain model being used for the HV simulation. It has been observed that the 3D models created from GIS data also show the georeferenced property.

In one embodiment, the GIS software used to view and process the data is Quantum GIS (QGIS). Quantum GIS is an open-source, multi-platform GIS software that displays vector and raster data and also has a suite of geoprocessing tools required to create 3D GIS models from the base 2D GIS database. The 3D models' dimensions, such as diameter, are obtained from the attributes of the buried utilities in the GIS database. In order to differentiate between different utility types, the 3D geometry can be shaded according to the one-call system-marking scheme.

In one embodiment, SeePlusPlus' (the system 32) collision detection and proximity query functionality may be designed using the proximity query package (PQP) library. The PQP library performs computations on 3D objects using their geometric primitives and the object's pose to give relatively accurate output. In order to make the geometric primitives available to the library, the 3D objects can be decomposed into their primitives. The decompositions can be stored in memory as tris files. The tris files, along with the pose of the object, are input into the PQP library. The process of decomposing 3D models into their constituent primitives can be achieved using OSG. Each tris file can be used for multiple instances of the same 3D model by substituting each instance's pose.

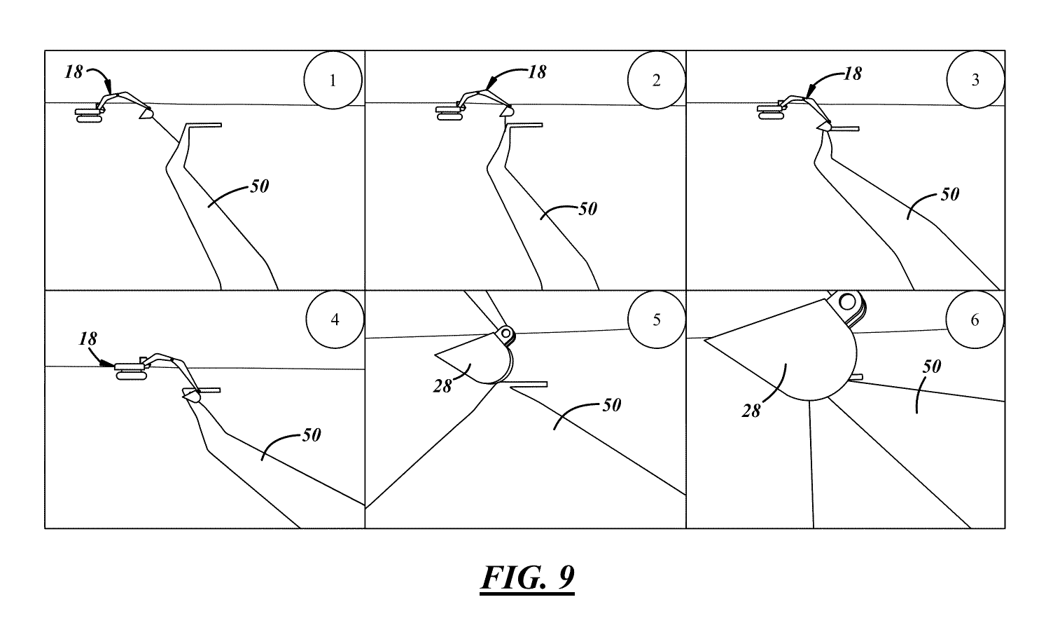

In use, the collision detection and proximity queries' functionality can be demonstrated using the example of an excavation construction jobsite. Referring to FIG. 9, the construction jobsite includes the excavator 18 and buried utilities 50. The SAGE 16 of the system 32 can display the distance of the excavator's bucket 28 to the buried utility 50 in its vicinity. Thus the excavation crew can take precaution when the bucket 28 and buried utility 50 are in close proximity, potentially avoiding an impact. FIG. 9 depicts the output from the PQP computations and 3D visuals from the simulation that display the accuracy of the computations. The output is shown in ascending sequence numbered 1-6. The excavator 18 is controlled using keyboard input in this simulation example.

### Geospatial Data Analysis Framework

In general, the geospatial data analysis framework deals with the computational details in the geometric modeling of geospatial utility data for 3D visualization and proximity monitoring. In one embodiment, the geospatial data analysis framework employs a set of specifications to serve as guidelines for each stage of geospatial data life-cycle in regard to the following parameters: interactivity, information richness, dimensionality, extensibility, and accuracy (IDEAL). In this embodiment, visualization schemes or implementations prescribing to this framework are capable of displaying a buried utility network in a 3D environment, complete with any utility attribute information that end-users, such as excavator operators, may require. Furthermore, implementations in the embodiment also provide additional decision-making support to help end-users complete an operation in an efficient and safe manner. A compliant visualization scheme may further characterize and display uncertainty associated with the position of the utilities through color-coded visual buffers surrounding the utility models to aid the end-user's decision-making process.

Generally, a visualization scheme can be categorized as interactive or fixed. An example interactive visualization is one that allows users to navigate through it, select an element for closer inspection, highlight areas of interest, or view the scene from different viewpoints. In one embodiment, the framework has a visualization scheme that is interactive in nature, allowing users to view attribute data for parts of the network. Other embodiments may have fixed visualization schemes. The display of on-demand attribute data and user-initiated changes to the displayed elements in the scene can call for visualization schemes to be rendered in real-time and at interactive frame rates. Studies have shown that a frame rate of 10-15 Hz (frames per second) is adequate for an interactive visualization without having adverse effects on human performance. Interactivity in the visualization may allow users to better perform their tasks. For example, a user interface that toggles transparency of a terrain surface gives the functionality of viewing underground infrastructure when terrain is rendered transparent. Users can also change the transparency so that surface features can be made visible and aid in location on the terrain. Users may further interact by selecting a specific utility from a large number of crisscrossed utilities that may be displayed in the scene. The selection could take advantage of attribute data and highlight the utility that a user may be interested in. These optional functionalities are schematically portrayed in FIG. 10, where transparency of a terrain 52 is depicted by image 54, and highlighting is depicted by image 56. Other interactive functionality may be possible in other embodiments.

Conventional visualization through as-built drawings, 2D CADD displays, and mapping software displays represent a buried utility as a polyline, but do not show the pedigree or lineage of the data. To understand the uncertainty associated with a particular utility line's location, a user has to refer to associated files beyond those used for display. Non-representation of this uncertainty in the visualization stage may result in the user operating in a misinformed state. In order to prevent such a possibility, in this embodiment the framework displays utilities so they not only show the location of utilities, but also a region of uncertainty around them. The region can be represented as a band or cylinder of uncertainty adjacent to the utility line, or as a halo surrounding it. The framework's display of any locational uncertainty associated with utilities can enable the user to make a decision to proceed with excavation or seek additional nondestructive detection techniques to be used before excavation by simply gleaning easy-to-understand information from the visualization.

In some cases, an effective visualization framework is as representative of the real-world as possible in order to be useful to the user for their decision-making process. Representing cylindrical conduits and pipes as polylines in a 2D visualization does not always achieve this. In this embodiment, the framework uses 3D models for displaying a utility network. The ability to view utilities in a 3D environment can enable users to view a complex network more clearly than is usually possible in paper drawings, CADD, or GIS 2D visualization. Commonly, multiple utility lines may be laid in a stacked manner, having the same horizontal location but varying depths. Viewing such a complex group in 2D leads to a clustered scene in which individual utility lines and their individual levels of uncertainty can overlap. The informative value of a 2D visualization can in this way be limited owing to the overlap of uncertainty bands and halos, which may cause difficulties for users like equipment operators to determine the specific locations and associated uncertainties of specific utility lines. Furthermore, visualization of a buried utility network in a 3D environment is inherently linked to the overlying terrain. In existing visualization methods—such as as-built drawings, 2D CADD, and GIS displays—users locate utility networks in relation to existing streets, landmarks, and other known features. In some instances, to emulate the real-world, a 3D visualization framework can include a 3D terrain model. Its absence leads to the lack of a reference point inside the 3D virtual world. In one embodiment, the framework thus has a scene in 3D that contains the utility network and the overlying terrain model.

Visualization can be the final stage in excavator operators' use of buried utility geospatial data. In addition to serving the purpose of viewing the utility network, visualization schemes may have other uses—such as displaying proximity values and collision warnings to buried utilities—computed by independent analysis processes. In one embodiment, the framework thus supports extensibility for processes beyond passive visualization alone. In the real-world, excavator operators are unable to see buried utilities like underground pipes covered by the earth and soil. Operators also do not have real-time information regarding the proximity of the digging implement (e.g., excavator bucket) to the buried utilities and thus are not warned of an impending impact. A 3D visualization in a virtual world may be capable of processes beyond those possible in the real-world, such as calculating the distance based on the 3D geometric models of the construction equipment and utilities, and issuing warnings to prevent impacts.

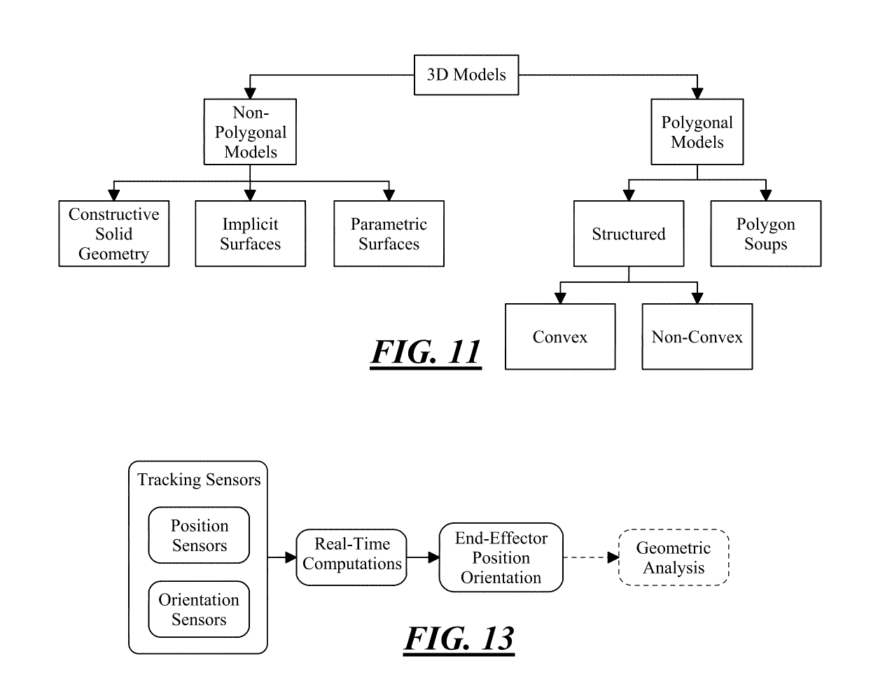

The ability to perform proximity analysis is a useful extension of visualization. The lack of depth information and the inability to see the buried utility can lead an operator into unintended impact with a buried structure while performing an excavation operation. The operator can be aided by performing computations using the 3D model of the construction equipment and those of the buried utilities. These computations can be based on the use of computer graphics algorithms that use 3D geometric models as input. The 3D models can be of a number of types, including those shown in FIG. 11. Polygonal models are commonly used in the field of computer graphics and 3D modeling. The polygons composing the model surface are triangles or quads.

An appropriate collision detection algorithm that accepts the selected 3D model type as input can be used for proximity and collision computations. As the visualization stage uses 3D models for the buried utilities, terrain, and construction equipment, in one embodiment the same 3D model format is adopted for all entities present in the 3D scene so that the utility models and construction equipment models can be used in the same collision-detection algorithm; this however, may not always be the case in other embodiments.

The accuracy of the visualization of buried infrastructure aids an excavation operator in the decision-making process. The aspect of accuracy encompasses multiple parameters, including the positional accuracy of utility data. In one embodiment, the framework may ensure the positional accuracy of the utility models through the use of georeferenced 3D models. Georeferencing is the process of registering objects based on their location attributes in real-world coordinate systems, for example GCS or PCS. Universal transverse mercator (UTM) is an example of a PCS. Universal transverse mercator provides a constant distance relationship anywhere on the map. In GCSs like latitude and longitude, the distance covered by a degree of longitude differs as you move toward the poles. This makes the use of GCS more suitable for maps representing very large areas. For engineering applications such as utility network representation, a PCS can enable the coordinate-numbering system to be tied directly to a distance-measuring system. When buried utility models are georeferenced, they are given an actual physical location that corresponds to their real-world location.

Georeferencing utility location can enable the visualization of utilities with other elements—such as a terrain model and real-world data (e.g., GPS sensor input). Without georeferencing utility models, the creator of the virtual scene manually specifies the location and orientation of each utility element, and adjusts its display scale during every interaction of the scene. Thus georeferenced buried utility 3D models help ensure the feasibility and accuracy of the visualization. In one embodiment, the framework uses a common coordinate system with the same units for storing or converting all elements of a scene, such as utilities, terrain, and sensors.

The dimensions and features of the utility models can affect the visualization accuracy. To be accurately visualized, the 3D utility models should represent real-world utilities in terms of shape and size. Shape is characterized by the cross-section type. It has been determined that in some instances a 3D modeling framework should have the ability to accept input data of any shape to produce identical 3D models. The commonly observed shapes for utilities are typically circular and quadrangular. Size refers to the diameter (or breadth) and height of the utility cross-section. The size data together with shape data determines the cross-section information of the particular utility. Both shape and size data are commonly archived in GIS databases as attribute data. In open data transmission protocols such as XML, the shape and size data can be captured using specific data tags.

In addition to shape and size data, it has been determined that in some cases an unambiguous approach is called for when specifying how the utility location data is collected and archived. During the data collection stage, location data is typically collected at every point in which the direction of the utility line changes. Using this approach, it is safe to assume that the utility line is a straight line between two successive points when viewed in a 2D planar view. Location data collected at every turning point consists of three elements: latitude for horizontal location, longitude for horizontal location, and altitude for vertical location. In the case of buried utility data collection, the altitude element can sometimes be the source of much uncertainty and error. For instance, the elevation data collected can refer to: the elevation of the ground surface; the elevation of the top, middle, or bottom of the buried utility; or any random location on the buried utility. The specific location on the utility structure at which the elevation is obtained should be recorded. It has been determined that recording the elevation of the top surface of the utility structure after it has been placed in the ground would lead to the least uncertainty and error. As this method would call for placing a GPS receiver pole on the utility crown, for example, it does not need addition/subtraction of a horizontal offset to correspond to the utility centerline. Also, this method directly measures the elevation of the utility (top) surface that is most likely to be impacted by construction equipment end effectors. A 3D modeling framework can take into account any horizontal or vertical offsets, as well as the type of location data being supplied to it, to create 3D utility models that represent the real-world buried utilities most accurately in terms of horizontal and vertical location, shape, and size.

Buried utility data is collected and archived for use in 3D modeling. In one embodiment, the utility data collection techniques use an interface that enable a user to store streaming GPS data to represent a series of utility vertex locations. This graphical user interface can allow a user to select the utility type, its cross-section shape, and dimensions. Data can be archived in an XML file when saved from the data collector. The XML files are then used to create 3D models of buried utilities. Thus buried utility data passes through stages of collection, archival, and visualization. The scenario would be the same for a buried utility whose location and elevation had previously been recorded appropriately. Thus the data flows through the stages, ultimately leading to a 3D visualization that implements the framework in this embodiment.

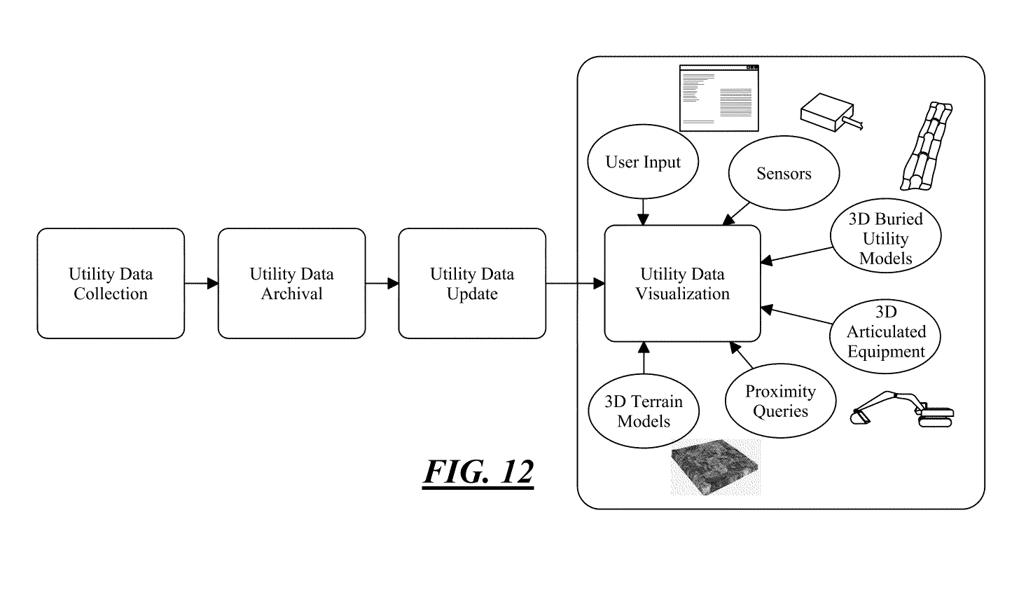

A visualization tool for buried utility maintenance, excavation, and other engineering applications calls for input from various data sources and can follow a sequence of processes, as shown in FIG. 12. Such a visualization conforms to an embodiment of the framework when there is: a provision for user input and interaction; use of 3D models to represent the buried utility network and other scene components such as terrain and construction equipment; and an extensible component such as proximity monitoring that takes input from real-world sensors.

A buried utility visualization and analysis environment has been implemented based on an embodiment of the framework for safe urban excavation operations. The visualization environment is based on scene graph architecture, with OSG being the specific scene graph implementation used. OSG-based applications can handle a wide range of 3D model formats, and thus the use of 3D geometry in the polygon surface format can be ensured. Scene graphs have a hierarchical tree structure for managing the level of detail, field-of-view, culling, transformations, and animation. These features allow user interaction through appropriate interfaces to customize the visualization. Scene graph implementations are based upon the lower-level graphics application programming interfaces (APIs), such as OpenGL. Thus the use of OSG for seamless 3D visualization can help satisfy the dimensionality requirements of one embodiment of the framework. The visualization's graphical user interface component can be developed using the cross-platform tool, Qt. The user interface can also enable users to create proximity queries between construction equipment and buried utilities to provide impact warnings.

Effective visualization can also prevent information overload and gives users the option to view only those parts of the scene that may interest them. In some embodiments, the user interface implementation allows users to view a scene in a manner that best suits them. For example, the visualization user interaction also allows users to choose the level of information they wish to see by turning on/off various layers (e.g., terrain) and toggling on/off utility attributes. Furthermore, through the visualization of the uncertainty buffer around a buried utility, as well as its proximity to surrounding utilities, field engineers can decide whether to proceed directly with a mechanical excavator or to employ additional precautions such as non-destructive testing and/or hand excavation methods.

The creation of 3D models of buried utilities for IDEAL visualization implementation is one of the data sources. This module is referred to as buried utility 3D modeling toolkit (B3M), and it can enable the creation of georeferenced buried utility models. Like the visualization, it can also be based on scene graph architecture, thus creating a direct link between the 3D models created and the visualization stage of the data. B3M is capable of creating models that can satisfy the requirements of embodiments of the framework, for example the display of utility attributes and the representation of location uncertainty through a buffer or halo. The 3D utility models created by B3M can adhere to the American Public Works Association (APWA) color-code. A polygon surface model can be used as the 3D model format, owing to its broad implementation and its ability to be used in downstream processes such as proximity monitoring. B3M can create georeferenced 3D models that are location-aware. Thus the 3D utility models are registered to the same spatial referencing system as their surroundings. In addition, the 3D models can contain utility attribute information. The presence of attribute information in 3D models allows them to be seen in visualization, and can help utility inspectors and equipment operators make decisions that improve the productivity and effectiveness of planned engineering operations.

In one embodiment, the B3M can handle multiple archived input formats. Currently, the most common formats used by organizations to store buried utility data are GIS, CAD, and XML. By, in some embodiments, ensuring that the 3D modeling framework can accept data in any of these formats, the visualization stage remains insulated from the data archival stage. The 3D buried utility models can be output in OSG's native binary format, as this format can be used in any OSG-based visualization implementation. But in addition to the native OSG format, output models can be created that are usable in other independent 3D visualization and modeling toolkits in other embodiments.

In GIS, utility pipes are typically modeled as polyline features, and utility junctions as point features. Shape, size, depth, and other information are treated as utility-specific attributes. A single utility represented as a GIS polyline feature typically consists of a number of straight line segments connected at turning points but represented as a single entity. In the real-world, a utility having bends consists of individual pipe segments that are joined to one another to create an overall single entity. Thus a pre-processing step is included in some embodiments to break down GIS polylines into straight line features connected at turning locations prior to 3D modeling. Through this step, a 3D utility consists of individual 3D segments and not one single entity. Following the pre-processing step, the location, depth, cross-section shape, and dimension can be retrieved from the GIS attributes to create 3D polygon models.

In some embodiments, the B3M framework can create 3D utility models from CAD input data. Similar to the approach of treating GIS input, B3M creates a 3D polygon model for every straight line segment in a polyline. This arrangement can ensure that every 3D model created is analogous to its representation in the real-world. Unlike GIS, which treats spatial and non-spatial properties seamlessly, CAD can require its attribute data (e.g., shape, size, type, service dates, owner, etc.) to be archived in separate files that are accessed by the 3D modeling framework during creation of models.

An XML document is referred to as an instance document. An instance document is based on an underlying structure that is referred to as a schema. An XML schema defines the elements and their order in an instance document, and is used to ensure that an instance document conforms to the preset structure. The data in instance documents is extracted through a process called parsing. In one embodiment, instance documents are checked for conformance with the schema document to ensure that data received by the modeling framework is valid. As users have control over authoring schemas, all of the information that creates accurate and informative 3D models can be made available to the 3D modeling framework. Thus a schema document can be modified to reflect the data transmission method from the archival stage to the modeling and visualization stage.

In one embodiment, the IDEAL framework calls for a visualization that is capable of extensible functionality beyond its core. The visualization implementation in this embodiment uses proximity monitoring and collision detection as the extensible feature. Geometric proximity monitoring is done through the implementation of the PQP library that uses polygon soup models as geometric input. The input is provided in the form of a list of polygons or polygon soup that represent the surface of a 3D model. Utility models being georeferenced are location-aware, hence their polygons can be used directly in proximity monitoring analysis. Such visualization can assist excavation operators by providing real-time warnings and visual guidance to prevent unintended utility impacts.

### Geometric Proximity Monitoring Framework

In one embodiment, the geometric proximity monitoring framework includes 3D geometry models, position, and orientation updates in order to perform proximity analysis, tolerance checks, and collision detection between a pair of objects or entities.

As operation proceeds, the graphical database is analyzed for proximity as well as impacts between entities. Results from the analysis can be used to trigger audio-visual warnings to notify the operator with vital information such as: 1) proximity of excavator's digging implement to buried utility; 2) breach of safety threshold; and 3) impending impact. The post-analysis reaction is tailored to suit the requirements of a specific operation. FIG. 13 illustrates computations involved in an embodiment of this framework. It includes three stages: tracking, representation in 3D, and analyzing. The technical approach is applied to an operation involving a dynamic entity, such as an excavator, and one or many buried utilities. However, the same approach can be applied to any operation involving a pair of dynamic entities or static entities, such as material or jobsite infrastructure. This approach employs real-time position-orientation tracking of dynamic entities and 3D geometric models representing the dimensions and positions of static entities. The final stage is completed by analyzing the geometric database consisting of all geometric entities involved in the operation.

Efficiency, accuracy, interactivity, ability to handle dynamic objects, and capability to process a large number of 3D CAD model shapes, sizes, and forms have been identified as suitable for methods designed for impact detection and interference analysis of 3D virtual construction simulations. Also, performing proximity queries in real-time by processing pose data is suitable. Output from the analysis stage—such as proximity between entities, potential impacts, and breaching of safety thresholds—can be used by downstream processes such as operator warning frameworks and equipment control mechanisms.

As set forth above, the framework in this embodiment includes tracking Excavation operations typically involve infrastructure that is covered by earth, mud, soil, and debris. Construction equipment is used to remove the overlying cover. Excavator buckets, for example, interact with the materials overlying the buried infrastructure. Accurate knowledge of the pose of the bucket can facilitate safe operations in some cases. Knowledge of the bucket's pose can then be used in the analysis stage to compute spatial relationships with infrastructure in its immediate surroundings. Due to the harsh nature of the work environment and operation, sensors cannot typically be placed directly on the bucket or other end-effector. In order to arrive at the pose of the bucket, a combination of multiple sensors and real-time computations is employed. As for the bucket, it is not practical to place GPS sensors in the bucket owing to potential damage due to constant interaction with the soil. The bucket's pose can be obtained in one embodiment through the use of a GPS sensor placed on the excavator's cab, and orientation- or tilt-measuring sensors placed along the rotating joints for the boom, stick, and bucket. This is described in greater detail below, and in briefer detail here.

Referring again to FIG. 13, as the pose of the end-effector cannot be directly obtained, computations are made with output from multiple position and orientation sensors placed on the equipment. Real-time calculations are performed to derive the end-effector pose. Thus the tracking stage determines the pose of the dynamic entity's end-effector or component that interacts with other construction jobsite entities. In one embodiment, pose determination is done through a process of forward kinematics. In forward kinematics, the final shape of the articulated chain is dependent on the angles explicitly specified for each of its links. The output has two components to it: position and orientation. A six-parameter vector is used to describe the spatial location and orientation of an object in space. The six parameters making up the vector are latitude, longitude, altitude, roll, pitch, and yaw. Position sensors such as GPS compute locations in terms of geodetic latitude, longitude, and altitude above an imaginary ellipsoid. These locations are provided with respect to a specific geodetic datum or reference coordinate system. For GPS, the datum is WGS-84. Position coordinates are sometimes converted from spherical units, such as latitude-longitude, to planar systems, such as UTM, where the latter are more accurate at representing smaller areas by preserving angles and not distorting shapes. Planar systems employ linear units, such as meter and foot, and thus measurements made in them can be used directly in distance and other computations, unlike spherical units.

Orientation is defined in terms of a triplet of parameters that includes roll, pitch, and yaw to compute the rotation of a body about its longitudinal, transverse (lateral), and vertical axes, respectively. Thus the output from the tracking stage in this embodiment is used to update dynamic entities and analyze their interactions with other construction jobsite entities, and also to create a graphical simulation of the construction jobsite.

As set forth above, the framework in this embodiment includes representation in 3D. Particularly, the second stage of the proposed technical approach is representing the construction jobsite operation being performed in a real-time 3D visualization. Three dimensional models or geometry can be represented in a variety of formats, such as wireframe models, surface models, solid models, meshes, and polygon soups. Depending on the level of realism required, 3D models can vary in accuracy, memory requirements, difficulty of modeling, and use in real-time rendering and analysis. But the choice of 3D geometry format also depends on the end application and real-world entity being modeled. Polygonal meshes are the most commonly used type of format to represent 3D geometry. Parametric representations of surfaces typically define a surface as a set of points. Non-uniform rational b-splines (NURBS) is an example of parametric methods. Applications that call for the use of a truly smooth surface at every scale find NURBS to be a convenient option to implement. Implicit surfaces define a set of points that satisfy a function F where F(x, y, z)=0, and all points that satisfy the criteria F(x, y, z)<0 define a solid that is bounded by the implicit surface. Constructive solid geometry (CSG) allows 3D shapes to be built from simpler primitives—such as cubes, cylinders, and spheres—through the application of boolean operations on them. Three dimensional file formats used within the CAD domain often store their geometric data such that CSG principles can be used to operate upon them.

Boundary representation (B-Rep) describes a solid in terms of its surface boundaries (i.e., vertices, edges, and faces). In B-rep, a data structure containing information about an object's edges, faces, vertices, and their topological relationships is used to represent it. As previously mentioned, polygon models can be the most suitable format for hardware-accelerated rendering. Hence the polygon soup class of polygon surface models can be used as the 3D model format to represent real-world entities and perform geometric analysis.

Dynamic entities on a jobsite are tracked using position and orientation sensors. Their equivalent 3D models in a real-time simulation are updated through position and orientation output from the tracking stage of this embodiment of the framework. But in order to monitor spatial relationships between static and dynamic entities, equivalent positional information should be made available regarding the location of static entities. This can be made possible through the use of georeferenced or location-aware 3D models. Georeferencing generally refers to the ability to assign a location attribute to data. The location attribute can be obtained through archived data sources such as GIS databases, infrastructure repositories, and as-built drawings. Static entities such as buried utilities, embedded rebar, temporary structures, and material stockpiles have their location information linked to the earth's surface. Thus, georeferencing ensures that 3D models representing static entities can be used in the same analysis with dynamic entities that utilize position-orientation information having a common coordinate system.

In order for a 3D visualization to simulate an ongoing operation, dynamic entities update their pose to match their real-world counterparts. In addition to the 3D visualization stage, updates made to dynamic entities are used downstream in the analyzing stage in this embodiment of the framework. Three dimensional models representing dynamic entities can give equipment operators a virtual 3D view of the operation they are performing, and concurrent geometric proximity analyses between jobsite entities.

As set forth above, the framework in this embodiment includes analyzing. The analysis of interference and/or interaction between geometric entities is intended to help construction equipment operators by providing improved spatial awareness. This can be achieved by carrying out computations in real-time (i.e., concurrently with the real-world operation). Polygon soups are made up of several hundred geometric primitives, and are often present in an un-orderly arrangement with no topological relationships between adjacent polygons. When a proximity query is made between a pair of entities, the objects' geometric primitives and their global positions and orientations combine to create the graphical database for the query at hand. Computational queries provide valid output when their underlying graphical database is current in terms of geometric makeup and object pose. The geometric primitive component of the graphical database generally remains the same unless there is a change in equipment type or configuration (e.g., a change of end-effector for an excavator). The pose is updated in real-time and maintains the fidelity of the database. Thus, both geometric content and pose information representing their real-world counterparts at all times helps ensure meaningful analysis.

Algorithms for the detection of interference between objects have applications that are relatively widespread and can be found in areas ranging from surgery simulation and games to cloth simulation and virtual prototyping. The set of spatial queries between a pair of objects are collision detection, exact separation distance computation, and approximate distance measurement to a tolerance value. A bounding volume (BV) can be used to bound or contain sets of geometric primitives such as triangles, polygons, and NURBS. Common types of BVs include spheres, axis-aligned bounding boxes (AABBs), oriented bounding boxes (OBBs), discrete oriented polytopes (k-DOPs), ellipsoids, convex hulls, and sphere swept volumes (SSVs). The efficiency of a bounding volume is typically affected by the choice of BV type. Efficiency is achieved by a trade-off between the tightness of fit and the speed of operations between two such BVs.

The underlying algorithm in one embodiment of the developed methodology uses sphere swept volumes as the BV type. First- and second-order statistical methods are used to compute the BVs. The mean and covariance matrix are computed for vertices of all triangles making up the object, and are used to summarize the object's primitive vertex coordinates. These types of computation details will be known to those skilled in the art. Here, an OBB is first constructed to enclose the underlying geometry using the Eigen vector of the covariance matrix computed for vertex coordinates. The second step consists of creating BVs of SSV type. Generally, there are three types of SSV: point, line, and rectangle SSV. The selection of SSV type can be based on the dimensions of the OBB constructed. The BVs are arranged in a hierarchical manner beginning with the root node that encompasses all geometry associated with an object, and ending with leaf nodes that contain only a single triangle. The BVs thus created at different node levels form a bounding volume hierarchy (BVH) using a top-down strategy. All of the triangles in a given node are split into two subsets, where each subset then becomes a child node of the current node. This subdivision continues until a given node contains only a single triangle or primitive and can no longer be further sub-divided.

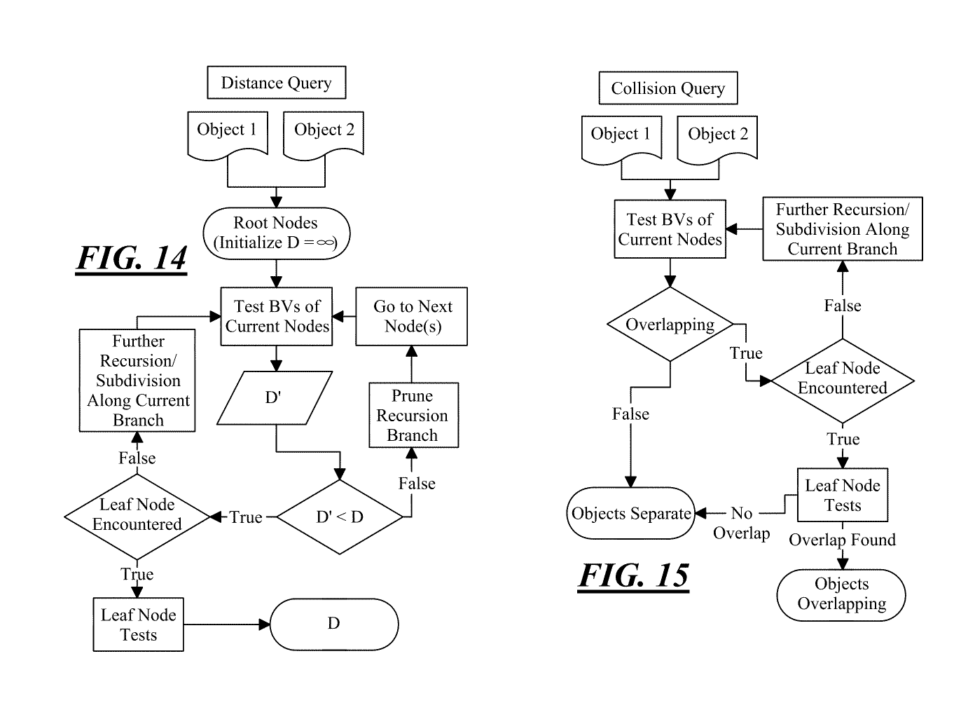

Triangles in a node can be subdivided in one embodiment based on what-is-known-as a splitting rule. The first step of the subdivision process is the selection of a suitable axis. The subdivision rule that is adopted in this procedure uses the longest axis of a box (i.e., OBB created for the geometry). If the longest axis cannot be selected then the second longest axis is chosen, or else the shortest axis is chosen. In the next step, a plane orthogonal to the selected axis is constructed. This plane acts as the partitioning plane such that polygons are divided into two groups according to which side of the plane their center point lies on. The subdivision process continues until a group of polygons cannot be further partitioned by this criterion (i.e., the group is considered indivisible or it encounters a leaf node that contains only a single triangle/primitive). Traversal of a BVH during a proximity query is referred to as bounding volume tree traversal (BVTT). The traversal begins at the root node and proceeds along the tree in a depth-first or breadth-first manner. The distance query returns the exact distance between a pair of objects, while the collision query returns whether or not they are overlapping, as illustrated by the flowcharts in FIGS. 14 and 15. In FIG. 14, D represents the separation distance between objects 1 and 2, and is initialized to a large value at the start; and D′ is the separation distance between current BVs.

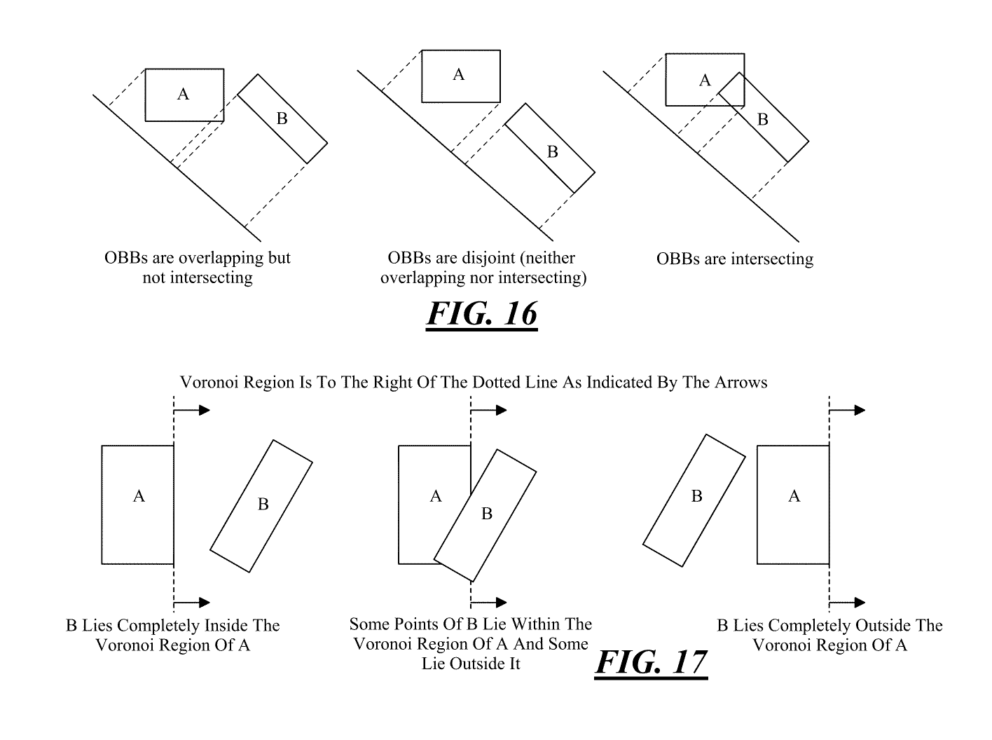

Overlap and distance computations can be performed using a multi-stage approach in one embodiment. The first stage is less computationally intensive and is used to eliminate a large number of test pairs from being passed on to the more computationally demanding second stage. In the first stage, OBBs are used to determine if two objects are disjoint or overlapping. The same computation is used by overlap as well as distance tests to eliminate or prune object pairs from further checks. The algorithm can be based on a separating axis theorem that will be known to those skilled in the art. A pair of bounding boxes to be checked for overlap is projected onto a random axis in 3D space. In this axial projection, each box forms an interval on the random axis. An interval is the distance between two projected points on a random axis. If the intervals of the boxes do not overlap, then the pair is disjoint/separate for that given axis. Such an axis is termed a separating axis. The separating axis procedure is graphically represented in FIG. 16. Once an overlapping axis is found, no further tests are required to check for overlapping.

If, on the other hand, the intervals are found to be overlapping, then further tests can be used to concretely determine whether the pair is separate or overlapping. Two boxes are disjointed when a separation axis exists that is orthogonal to a face of either box or orthogonal to an edge from each box. Each box has three unique faces and three exclusive edge orientations. Thus a total of fifteen (six face combinations and nine pair-wise edge combinations) separating axes exist for a given pair of boxes. If no separating axis exists, then the boxes are overlapping; and if the current OBB is a leaf node (i.e., bottom-most node enclosing a geometric primitive), then the pair is passed to stage two for further computations.

The second stage can be more computationally demanding and checks for overlap between underlying geometric primitives. If primitives are found to intersect (i.e., no separation distance between primitives), the computation—which uses a list of primitives making up the object—determines which primitives on each object are intersecting, and their exact points of intersection. If primitives are found to be separate, the separation distance between them is calculated. Computation and algorithm details involved in the stage two leaf-node tests will be known to those skilled in the art. In one example, the algorithm first determines if the closest points between the primitives lie on their boundary edges. This can be determined through the use of external Voronoi regions. An external Voronoi region for an edge A of a primitive is defined as the region of space outside the primitive in which all points are closer to edge A than any other features of this primitive. According to an example algorithm, there are three possible configurations for a pair of edges, A and B, belonging to two primitives: (1) edge B is present entirely inside the Voronoi of A; (2) B is present entirely outside the Voronoi of A; and (3) some points of B are inside the Voronoi of A, and some are outside, as shown in FIG. 17. From a possible sixteen pairs of edges, if no pair satisfies the requirements of the algorithm, then primitives are either overlapping or the closest point lies in their interior. Cases one and two (two leftmost in FIG. 17) are simple acceptance rejection configurations, while case three (rightmost in FIG. 17) calls for additional tests to be performed.

To determine if primitives are overlapping or separate, in one embodiment a modification of the separating axis theorem used in stage one for OBB comparison is used. Primitives are projected onto a unit direction and the distance between intervals is computed. This value represents the lower bound for the actual separation distance. If one of the closest points is in the interior of a primitive, the maximum magnitude of the normal vector to each primitive gives the upper bound of the separation distance. If both the lower and upper bound values are zero, then the primitives are overlapping.

The example algorithm can use optimization techniques to speed up computations and by pruning nodes sooner in the tree traversal. It can optimize proximity queries through a technique called priority directed search. Priority queue is a variation of the conventional queue data structure in which elements have a user-determined priority associated with them. Elements with higher priority are given preference over elements with lower priority. The priority in this case decides the order in which proximity tests are to be performed. The algorithm for proximity queries assigns priority based on the distance from the current BV pair. Closer BV pairs are given higher priority and checked prior to BVs lying farther away. Another technique used to optimize proximity queries takes advantage of coherence between successive frames of motion. The distance between a pair of objects changes by relatively small amounts between successive frames due to the high frequency of performing proximity queries. The closest pair of triangles from a given query is recorded or cached, and their corresponding separating distance is used to initialize D rather than using a very large value as shown in FIG. 14. This technique is known as triangle caching. As the distance moved is very small, the value of D from a prior frame is very close to the current D between a pair of objects.

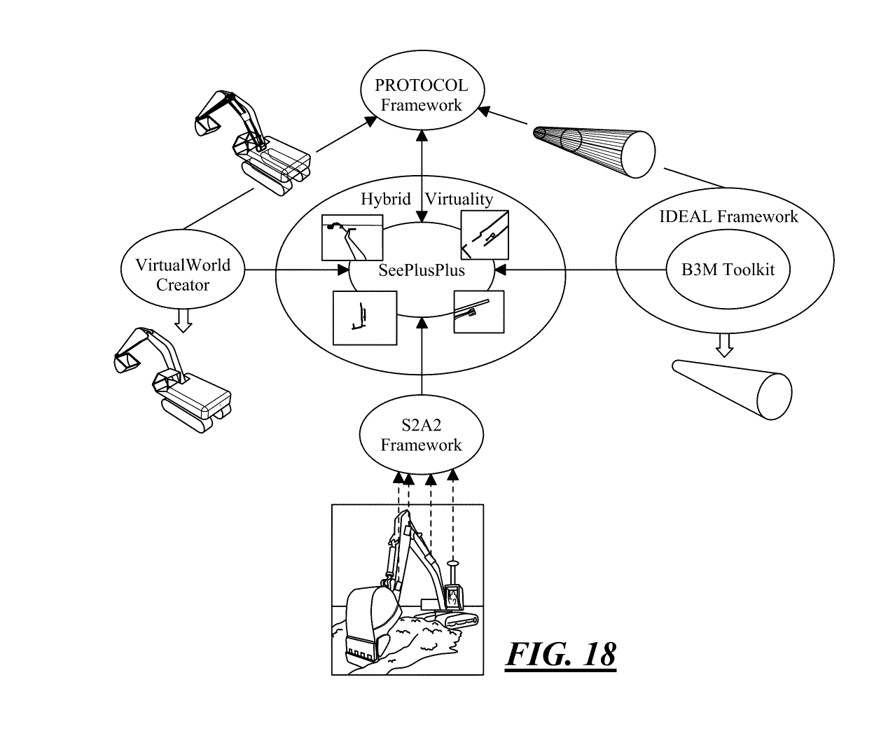

FIG. 18 shows an embodiment of the overall real-time simulation framework—that is, the overall method and system of monitoring proximity of objects—to assist excavation operators in carrying out operations in the presence of buried utilities, and thus in avoiding unintended impacts. The overall framework is generic and can be used to simulate any construction operation where operators experience reduced visual guidance and spatial awareness. SeePlusPlus, previously described, is the 3D visualization component of the framework that offers users a virtual, interactive view of the ongoing operation. In this embodiment, a sensor stream acquisition allocation (S2A2) framework is responsible for transmitting pose sensor data from the real-world jobsite into the virtual world. Thus input from S2A2 is used to update 3D models in the visualization and real-time spatial queries. There are dedicated modules for creating static and dynamic 3D entities. The B3M toolkit, previously described, is used to create georeferenced 3D models of buried utilities. These models can be directly used in the simulation due to being location-aware. A so-called VirtualWorld Creator in FIG. 18 provides 3D models representing articulated construction equipment used in the operation. In this embodiment, PROTOCOL is the module responsible for providing spatial queries by using 3D models representing static and dynamic entities, using sensor input from the real-world, and providing audio-visual warning feedback to the user for impact avoidance.

PROTOCOL is a software module that is designed to integrate with a 3D visualization system and allow users to make spatial queries. Users can select between proximity monitoring, collision detection, and tolerance checking queries. PROTOCOL's geometric computational functionality is designed using the PQP library. The PQP library uses the geometric primitives that make up objects, as well as objects' global poses, to compute the proximity between two or more objects. The use of low-level geometric primitives for distance computation and collision detection ensures that these computations can be made to a much higher resolution than what would be possible through the use of bounding volumes alone. But the use of polygon surface models, when used, to represent static and dynamic entities means that 3D objects should be decomposed into their primitives in order to be used by the algorithms. The decompositions represent a polygon surface model as a list of its constituent triangle primitives; the decompositions are stored in memory as tris files. A 3D model composed of quads or other non-triangular primitives is also automatically decomposed into its equivalent list of triangles. The geometric primitives representing a rigid body remain consistent throughout its operation. Thus pose updates from real-world sensors, when combined with tris files, can represent a real-world entity's pose in a virtual world. Every tris file can be used for multiple instances of the same 3D model by simply substituting each instance's position-orientation.

PROTOCOL is implemented as a plugin to SeePlusPlus and can be presented to the user as a graphical user interface (GUI) where queries can be created between entities. One-one and one-many relationship queries can be created. Any combination of distance, collision, and/or tolerance queries can be instantiated between two entities. Tolerance queries can be used to check if a predetermined safety threshold distance has been breached during operation. The GUI can be designed as a tabbed widget, thus enabling users to switch easily from one view to the next. The GUI can also provide an option to render a line joining the closest points between a pair of objects; this line is meant to assist operators in identifying the entities that are participating in the query when the number of entities is high. In addition, queries created in PROTOCOL can be saved and re-used for future use. This feature is conceived as being useful in scenarios where the end-user, such as an equipment operator, can load a pre-created virtual scene and proximity queries without having related expertise in those areas.

The two parameters to measure a proximity monitoring framework's effectiveness are measurement error and latency. Measurement error in this case refers to the error of the computed distance with regard to the ground truth or theoretically expected values. Latency in this case is a measure of time lag between an event occurring in the real-world and a proximity monitoring framework providing output to warning systems that end-users depend upon. Testing details of these facets requires the design of appropriate experiments. Experiments were carried out to test the measurement error and latency of the PROTOCOL module. The experiments were carried out at the Intelligent Sensing and Automation Testbed (ISAT) at the National Institute of Standards and Technology (NIST) in Gaithersburg, Md.

PROTOCOL's proximity measurement performance was evaluated in this experiment. The metric for PROTOCOL's proximity measurement performance was the difference between PROTOCOL's reported proximity and the ground truth or theoretically expected values. Any variations between computed and expected values will demonstrate PROTOCOL's contribution to computational errors. However, in order to ensure that any errors are purely computational and do not originate from position and orientation tracking, a tracking system with sufficient accuracy was used. Commercial GPS units are capable of sub-centimeter position accuracies using certain technologies—such as differential-GPS (DGPS) and real-time kinematic GPS (RTK-GPS)—their accuracies can be reduced due to environmental factors, surroundings, and line-of-sight to the sky. Thus the use of outdoor GPS or technologies that cannot guarantee a consistently high level of positional accuracy may adversely affect the computations performed by PROTOCOL. If position tracking is inaccurate and the magnitude of uncertainty cannot be measured, the difference between PROTOCOL-computed distances and theoretically expected values cannot be attributed to either positional input or PROTOCOL computations.

In order to ascertain the cause of uncertainty, a tracking system capable of consistent readings was used for this experiment. Indoor GPS (iGPS) is one such tracking technology that is capable of sub-millimeter (±0.250 mm) position tracking accuracy. iGPS can be compared to the global positioning system's constellation of satellites in which each indoor transmitter plays a similar role to a GPS satellite. Instead of satellites, iGPS uses infrared laser transmitters that emit laser pulses. When a receiver obtains pulses from more than a single transmitter, that receiver can compute its position and orientation within the coordinate system defined by the transmitters. Photo detectors pick up the signals and compute angles and positions based on the timing of the arriving light pulses.

The radius and center of the test sphere used in the experiment was measured using the iGPS. Distances measured with the iGPS were treated as the ground truth. The test sphere and probe tip used in the experiment were modeled as polygon surface spheres to be used in a geometric proximity analysis and real-time 3D visualization. The proximity test consisted of a series of seven iterations starting at a distance of less than 0.3048 meters (1 foot) surface-to-surface separation between the test sphere and the probe tip. Successive iterations were made at 0.6096 meters (2 feet) increments. For each iteration, ten readings were made to account for variations in the iGPS tracking For every measurement, the error (i.e., the difference between the value computed by PROTOCOL and the ground truth) was calculated. Table 2 below shows the separation distance error for the complete range of separation distances. Since the iGPS positional uncertainty for a given point is 0.250 mm, the difference between two iGPS points can vary by a combined 0.354 mm, where 0.354=J(2*(±0.25²)).

TABLE 2

| | | Ground Truth | PROTOCOL | |
|---|---|---|---|---|
| | Nominal | (Average for 10 | Computed | Δ (mm) |
| | Separation | readings) | (Average for 10 | [Computed − |
| Iteration | Distance meters | (mm) ± | readings) | Ground |
| # | (feet) | 0.354 mm | Distance (mm) | Truth] |
| 1 | <0.305 (1) | 290.360 | 292.420 | 1.560 |
| 2 | 0.305-0.914 (1- | 724.730 | 725.878 | 1.148 |
| | 3) | | | |
| 3 | 0.914-1.524 (3- | 1188.768 | 1189.552 | 0.784 |
| | 5) | | | |
| 4 | 1.524-2.134 (5- | 1856.836 | 1857.434 | 0.598 |
| | 7) | | | |
| 5 | 2.134-2.743 (7- | 2475.590 | 2476.090 | 0.500 |
| | 9) | | | |
| 6 | 2.743-3.353 (9- | 3032.077 | 3032.490 | 0.413 |
| | 11) | | | |
| 7 | >6.096 (20) | 7073.196 | 7073.520 | 0.324 |

A proximity monitoring system should be capable of analyzing input and providing real-time or near real-time output in order for it to be useful. Two main causes of dynamic distortion in real-time computer graphics systems have been identified as lag and frame rate. In these experiments, lag was defined as the time offset in the data stream from a tracker to the graphical image. It was also observed that the frame rate depended upon the scene complexity, varying from very simple renderings to those requiring considerable computation, and renderings in response to user movement.

In its basic form, latency is a measure of the overall delay in a system. However its constituent time delays and their measurements are system- and implementation-specific. In the case of PROTOCOL, the delay is measured between an event occurring in the real-world and a warning being given to the user by the system. For example, if PROTOCOL is set to a tolerance mode of one meter, the system must provide output for audio/visual warnings when two entities are within one or fewer meters of each other. The time delay between entities coming within the tolerance distances in the real-world and audio/visual warnings being provided to the user is an example of overall system latency.

System latency in relation to PROTOCOL was further sub-divided into incoming external latency, internal latency, and outgoing external latency based upon the time taken to complete specific tasks. Incoming external latency refers to the time taken for sensors placed on or around equipment to register a change in position-orientation and transmit it to PROTOCOL. Incoming external latency is a function of the data transmission medium chosen and the refresh rates of the sensors. Internal latency is the time taken by PROTOCOL to update the existing graphical database and perform a geometric analysis. Hence internal latency is a function of scene complexity and the number of entities being modeled, and the number and types of queries being performed. Finally, outgoing external latency is the time taken to transmit the analysis output to the audio/visual systems that process and supply appropriate warnings to the user. It follows that outgoing external latency is a function of the data transmission medium and the types of warning devices being implemented. A visual warning mechanism that is part of the visualization framework can reduce the time to negligible values, while disparate warning devices (e.g., audible alarms) can add additional time due to additional transmission being involved.

In this experiment, a tolerance trigger was used to measure the latency of the system. The experiment setup was identical to that of the distance test, including the i6 probe, test sphere, and iGPS transmitter layout. The test was designed to trigger a visual warning whenever the probe tip was within 30.48 cm (1 foot) of the test sphere, as measured by PROTOCOL.

Four iterations of the latency test were performed, and the three constituent latencies making up overall latency were recorded, as shown below in Table 3. TCP/IP socket connections were used to transmit pose data from the iGPS server to PROTOCOL's input stage. Due to the high frequency of streaming data it was ensured that time durations of incoming, internal, and outgoing segments were computed accurately by recording time stamps along with the pose coordinate for every packet of data. Thus an individual pose coordinate's progress from the iGPS server through the entire visualization system could be tracked without error. Incoming external latency was measured as the time offset between a pose data point being streamed by the iGPS server and being received by the visualization system. Internal latency was measured as the time between a data point being received and its proximity analysis being completed. Outgoing external latency was measured as the difference in time stamps between analysis being completed (and warning being detected) and the visualization system acknowledging the warning condition by altering the screen color from white to red.

TABLE 3

| | Incoming External | Internal Latency |
|---|---|---|
| Iteration # | Latency (milliseconds) | (milliseconds) |
| 1 | 15.4 | 13 |
| 2 | 8.0 | 20 |
| 3 | 3.3 | 18 |
| 4 | 8.1 | 10 |

In addition to the above, the iGPS system has an associated latency due to the frequency at which it updates readings. The iGPS system has an update rate of 40 Hz, which implies that a data point transmitted by it has an associated latency of 25 ms. During the experiments, the probe was being moved at an average speed of 0.54 m/s. As the iGPS system updates the location at 40 Hz, the probe tip's reported position can be up to 13.5 mm behind its actual position in the real-world. For a given sensor and its corresponding dynamically tracked entity, the offset would increase with greater speeds of motion and/or reductions in the position update frequency.

What-is-known-as the Nagle algorithm that coalesces smaller data packets into fewer larger packets is understood to be one of the causes for transmission delay in the case of incoming external latency. Investigation of the data stream from the server application showed that a similar coalescing of data points was occurring with multiple data points having the exact timestamp. As a result of multiple data points being sent in bursts, the time offset for some of the incoming external latencies was observed to be very high, and were ignored for the purposes of mean and standard deviation calculations. In this implementation of the visualization system, the incoming sensor stream updates are associated with the update traversals of the overall visualization system. As a result, the sensor stream data has some additional latency due to it residing in the client socket's buffer prior to being processed. Internal latency times showed a relatively consistent value for analyzing the graphical database consisting of the test sphere and the probe tip. The outgoing external latency was negligible since the 3D visualization itself was used to provide visual warnings.

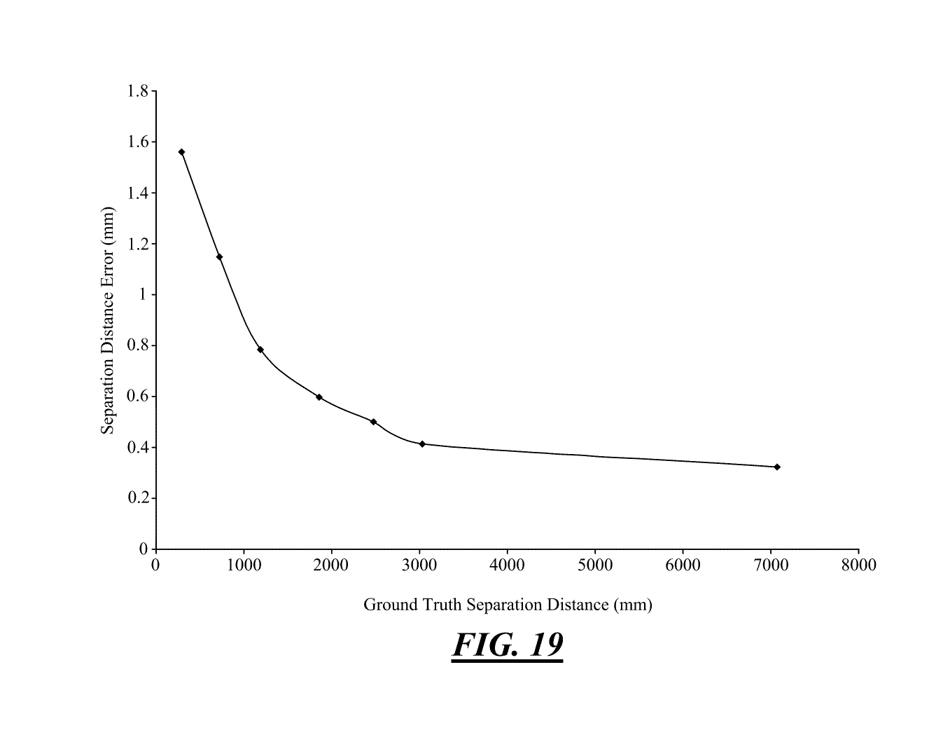

The distance test results show that the mean separation distance error with the standard deviation is 0.761±0.446 mm. FIG. 19 shows a plot of the separation distance error as a function of the ground truth separation distance. The trend of increasing error as the separation distance decreases is potentially due to the position of the iProbe during the tests. In the case where the test sphere and iProbe were in close proximity, the receivers on the iProbe were partially blocked by the test sphere, resulting in small variances of the reported position. As the reported position of the iProbe tip's center is used to place its corresponding 3D model, variances of the reported positions led to unintended translations in the 3D model.

The latency test showed that the mean incoming external latency with the standard deviation was 8.7±4.99 ms. Mean internal latency with the standard deviation was 15.25±4.57 ms. The observed values of incoming external and internal latencies yielded frame rates in the range of 15 to 24 frames per second (fps) or Hz, as observed in the OpenSceneGraph-based visualization. The frame rate did not yield any noticeable lag in operation and also provided fps values that lie in the minimum acceptable range of 15-30 Hz for real-time rendering, giving smooth continuous motion.

### Construction Equipment Articulation Tracking Framework

In one embodiment, the construction equipment articulation tracking framework creates kinematically equivalent 3D models of articulated construction equipment such that their dimensions, rotation, and position of end-effector match and mimic that of their real-world counterparts. Here, the framework can connect sensors from the real-world construction jobsite to update corresponding components of articulated 3D models in the virtual world through allocation of sensor streams. In general, the particular sensors equipped to construction equipment may be dependent upon the piece of equipment itself and upon the operation being performed by the piece of equipment.

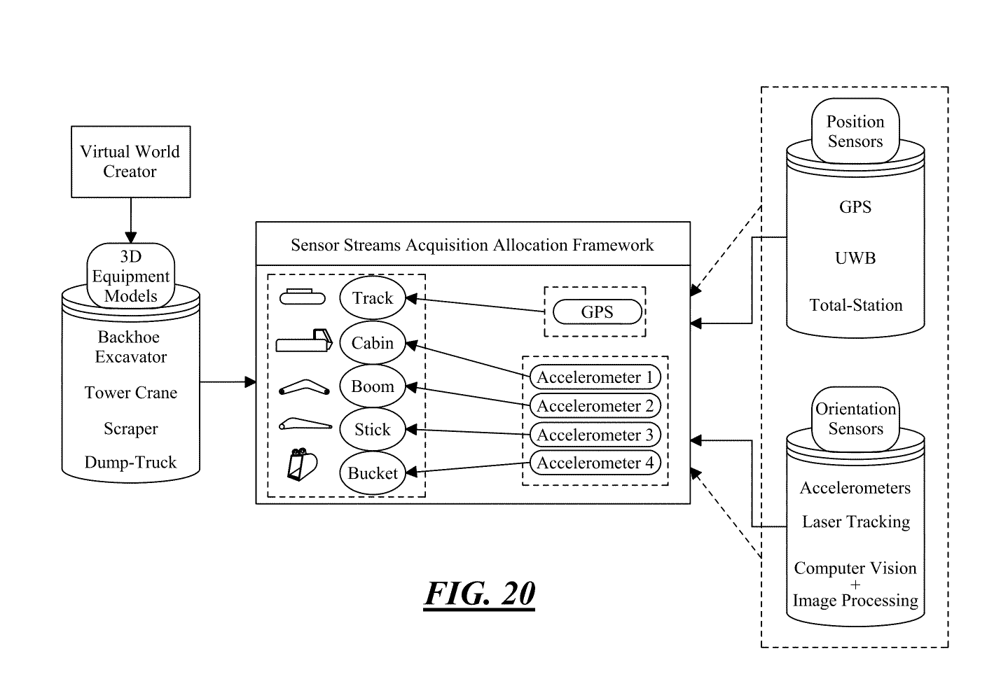

For real-time visualization, position and orientation sensor data from the construction jobsite is used to update the corresponding 3D equipment models in the virtual world in order to maintain a valid geometric display and related operational state. Equipment used on construction jobsites is often articulated in nature, i.e., its individual components are linked through joints and hinges that allow rotation about their pivot. Examples of these types of equipment are hydraulic excavators, backhoe loaders, graders, dump trucks and haulers. Monitoring such equipment involves recording the rotation and translation the equipment undergoes. In one embodiment, the data collected is then transmitted to a 3D virtual world so that the real and virtual worlds can be geometrically correlated to one another. The 3D models in the virtual world when combined with the stream of position-orientation data can be used for carrying out proximity analysis and collision detection. Finally, the 3D visualization and related analytical output are presented to the operator. The entire process occurs in real-time or near real-time so that the output can be used by operators in their decision-making process. Thus, being able to represent and simulate dynamic articulated equipment from the real-world jobsite concurrently in a 3D virtual world calls for a link joining the real and virtual aspects of the operation. There can be a level of relative complexity due to numerous types of construction equipment often being present on a jobsite, at any given instant. Similarly, an equipment's position and its sub-components' orientation can be recorded and monitored through a wide range of sensors and techniques. It follows that the proposed methodology is generic in its scope if intended to be applicable to a broad range of projects. The proposed methodology is represented schematically in FIG. 20 with the data from the real-world interfacing with individual components of the equipment in the virtual world.

FIG. 20 uses an excavator model to schematically show how the equipment's components can be connected to position and/or orientation sensor sources from the real-world. The generic framework presented is capable of performing a similar allocation of sensor streams to different equipment such as a grader, crane, or backhoe loader based on the configuration of sensors installed on them. Similarly, the position and orientation sensors can vary from one construction jobsite setup to another, examples of which are presented in FIG. 20. Thus the framework can provide the ability to work with non-restrictive configurations of sensors and 3D equipment models. Understanding of the underlying equipment motion concepts facilitates the replication of the real-world motion of articulated equipment concurrently in the virtual world. This is mostly due to the complexity inherent in equipment such as backhoes and excavators, where it is not always feasible to obtain the location of the end-effector in a direct manner. These limitations in turn are created by potential damage the sensors can suffer if placed directly on the end-effector (e.g., bucket) where they can come in contact with dirt and soil over the course of construction operations.

In general, kinematics is the branch of mechanics that deals with the study of motion of a singular object or a group of objects without considering their causes. The field of kinematics itself is further divided into two approaches—forward and inverse kinematics. Forward kinematics refers to the use of the kinematic equations to compute the position of an object's end-effector from specified values for the object's joint parameters. Inverse kinematics on the other hand is the reverse procedure of forward kinematics. It is used to compute the angles and/or lengths of individual links and joints of the object and the rotations and translations that the object must undergo in order to be present at a required (predetermined) final position and orientation.

In the case of equipment monitoring and operator assistance, the joint angle rotations are recorded by the sensors and thus the end-effector's position and orientation, P_{end-effector} is computed through a forward kinematic process where P_{end-effector} can be mathematically stated as f(Θ, L) for every rotational joint and arm from the object's base to the end-effector, where Θ is the rotational angle of the joint and L is the length of the arm rotating about the pivot for every joint. Hence, the kinematic chain relationship for an excavator's boom, stick, and bucket is P_{end-effector}=f(Θ, L)_{boom}+f(Θ, L)_{stick}+f(Θ,L)_{bucket}. The bucket's position and orientation depends upon the cabin's position and the sum of the lengths and the rotational angles of the boom, stick, and bucket respectively. The lengths of the boom, stick and bucket are considered from pivot-to-pivot so that the principles of forward kinematics can be applied to the computation. It should be appreciated that there are limitations on sensor placement upon construction equipment due to physical constraints and the harsh environment the equipment end-effector operates in. As a result, placing a position sensor on the end-effector that comes in contact with soil and other materials is difficult to achieve. Thus the end-effector's global position, i.e., position of its tip in relation to other entities on the jobsite, is computed in an indirect manner.

Determination of the global position of an end-effector tip can have two computations associated with it. The first is the position aspect of the equipment on the earth's surface, i.e., on the construction jobsite. The second involves the articulated chain of linked elements associated with the equipment. Thus, in the example of the excavator, a GPS receiver is placed on the top of the backhoe to provide the equipment position on a jobsite in terms of latitude, longitude and altitude. In some cases, a pair of GPS receivers is placed on the cab of the equipment to provide more accurate position as well as orientation (rotation) of the cab. Data from tilt measuring sensors placed along the boom, stick and bucket arms in combination with lengths of the respective components can provide the distance of the end-effector tip, measured from the articulated chain base, i.e., the pivot point of the boom. Based on the placement of the position sensor on the equipment, there may be an offset between the position reported by the sensor and the base of the articulated chain. Accurate integration of the two data computations calls for the inclusion of the offset distance between the base of the articulated chain and the position reported by the position sensor. The combination of every f(Θ, L) along the articulated chain provides only the position of the end-effector with respect to the base of the articulation. In order to convert this value to its global position so that position value can be compared to other entities on the jobsite, the base pivot offset is used.

Elements along the kinematic chain have a set of rotation axes associated with it. The origin of the local axes corresponds to the rotation pivot of the element under consideration. At the same time, sensors placed on the equipment components can record the rotation with respect to a set of global axes that are common for all the elements making up the equipment. Thus, there may exist a set of global axes. These axes are called the X-, Y- and Z-axes and are defined such that X-axis points in the horizontal direction to the right, Y-axis orthogonal to the plane defined by X- and Z-axes and in a direction pointing away from the reader, while the Z-axis points in the vertically upward direction. The three commonly used terms to describe rotation of a body in 3D space are roll, pitch and yaw. Roll is the rotation experienced about the X-axis; pitch is the rotation about Y-axis and yaw, the rotation about Z-axis.

Equipment components in an articulated chain have a parent-child hierarchical relationship. Hence, in the example of an excavator, the track component is the parent of the cabin, boom, stick and bucket elements. Similarly, the cabin component is the parent of the boom, stick and bucket components. In such a parent-child relationship, any rotation or translation experienced by the parent is implicitly transferred to the child entities. For example, anticlockwise rotation of the cabin by ninety degrees about the Z-axis, results in rotation of the cabin as well as its child elements—boom, stick and bucket by the same magnitude. However, the track component, which is the cabin component's parent element, is unaffected by this rotation. Due to such rotation and translation of individual components, the position and orientation of the local origin of the coordinate axes gets altered. This results in change in direction of local X, Y and Z axes. For example, rotation of the boom component in an anti-clockwise direction results in corresponding rotation of the stick and bucket components by the same magnitude. Due to this, the local axes direction of X, Y and Z differ from their global directions, i.e., directions corresponding to zero translation and rotation.

The cumulative effect of the parent components' rotation on a given element's local axes can represent an important parameter in computations as the rotation angles reported by orientation sensors are typically computed with respect to absolute global axes (e.g., the horizontal and vertical directions are computed with respect to the ground surface). Thus in one embodiment rotations imparted to the 3D models representing the components in the real-world should be geometrically transformed so that the real-world rotation from the sensors correlates to the existing rotation value of the 3D model component. The transformation is achieved by converting local rotations of individual components to their respective global rotation values.

A 3D model used to symbolize equipment in the real-world can generally represent the real-world to varying levels of realism and detail. But for 3D visualization and proximity analysis of the construction operation to be valid and useful to the operator, in some cases kinematic and dimensional equivalence should exist. Kinematic equivalence, in this context, refers to the property of a 3D model to concurrently mirror in the virtual world, the rotational and translation motion that a piece of equipment and its sub-components undergo in the real-world. This implies that the rotation or translation of a component resulting in a position change of an end-effector in the real-world, must be replicated in the virtual world in such a manner that the end-effector has the same global position in the virtual world as it has in the real-world.

The effect of kinematic non-equivalence may be evident in the case of objects having curved bodies or objects having bends in their physical makeup such as excavator booms and sticks/dippers. In such objects, the physical characteristics can result in difference between the axis corresponding to a certain edge and the pivot-to-pivot rotation axis. For most construction equipment components, the sensors can be often placed along an edge of the body to ensure its position remains fixed during the course of operations and the sensors record the angle of a known edge in the real-world. In order to help ensure that the 3D model in the virtual world has kinematic equivalence to its real-world counterpart, the angular offset between the actual rotation axis and rotation axis corresponding to the sensor and boom edge can be accounted for while transmitting orientation values from the real to the virtual world. In the specific scenario of the boom object, the angular offset can be subtracted from the orientation sensor angle before being applied to the 3D virtual boom model. This helps ensure that the boom tip will have the same global position in the real and virtual worlds.

The concept of dimensional equivalence refers to the characteristic of a 3D model and its sub-components to represent the real-world equipment's constituent components in size and placement. In some cases, when the 3D models used to represent equipment in the virtual world do not have identical dimensions to the real-world equipment components, the following constraints are identified. First, any sub-component forming part of the overall 3D equipment model must have the identical dimensions to the real-world equipment component such that the extents along X, Y, and Z axes (i.e., length, width, and height dimensions) are identical in the real and virtual world. Through this constraint, rotation of equipment components in the virtual world results in the position of the component extremity being identical to the real-world. Without dimensional equivalence, use of correct sensor rotation values may not provide the same global position for the component's extremity and in turn that of the end-effector. Furthermore, in some embodiments, for the geometric proximity analysis carried out on equipment components to provide values that are representative of the distances between the equipment and other jobsite entities (e.g., buried utilities), the dimensional extents should be identical for the real and virtual world components.

The second constraint with respect to dimensional equivalence relates to location of base pivot joints and their height with respect to the ground surface. In the case of the kinematic chain representing the boom, stick, and bucket, the position of the end-effector tip in global space can be dependant upon the height of the joint corresponding to boom rotation pivot. Thus, in addition to accurate rotation angles and dimensions, the height of base pivot points and their distance with respect to other pivot joints helps ensure accurate replication of the real-world equipment operation inside a 3D virtual world.

As described earlier, construction equipment monitoring is achieved through a combination of sensors placed on the equipment and replication of the equipment movement (translation and/or rotation) in a 3D virtual world. This virtual world provides operators with visual assistance as well as additional spatial context information to allow them to perform their task better. Thus, it becomes evident that representation of equipment in 3D in an accurate and real-world representative manner facilitates the proposed equipment monitoring approach. Objects present in a 3D virtual world may appear as a single cohesive entity. However, some objects are made up of one or more constituent components. Articulated construction equipment is an example of this. For instance, a construction crane consists of a cabin, boom, cable, and hook; a backhoe similarly consists of a tracked or wheel base, a cabin, a front end loader, and a boom, stick and bucket at its opposite end. Thus it can be seen that equipment of such type consists of more than a solitary sub-component, each of which is capable of translation and/or rotation. The components in turn are linked to each other through a parent-child hierarchy, where translation or rotation of a parent component results in corresponding movement in a child component. This parent-child hierarchical representation can be captured in a data representation structure called scene graphs through their layout and structure. Through the use of scene graphs, equipment components can be ensured to be dimensionally as well as kinematically equivalent.

One challenge in designing effective equipment monitoring is the ability to connect a wide range of position and orientation sensors from the jobsite to 3D virtual model components for any of the commonly used equipment in the real-world. Thus scalability and non-specificity (or generality) have been identified as requirements in some instances for transmission and linking of real-world sensor data to the virtual world. Scalability refers to the ability to connect any number of sensors from the real-world to 3D virtual equipment components in the real-world. Non-specificity entails that sensors from the real-world can transmit data and be connected to any equipment in a 3D virtual world that is representing its real-world counterpart. In one embodiment, these requirements can be enabled through a server-client approach to equipment monitoring. The server refers to the part of the framework that is responsible for recording and transmitting real-world sensor data in an appropriate data format to the client. The client, in this case, equates to the virtual world, i.e., 3D visualization and proximity monitoring that would consume the real-world sensor data. Insulation of the client from the sensors used on a jobsite ensures that the visualization and proximity monitoring are not restricted by the type of position or orientation sensors that may be implemented. In addition, this arrangement also allows multiple sensor data streams to be made available for the client.

The common denominators for data transfer can be specified through data structures for position and orientation. The position aspect of equipment on any jobsite can be accurately described through its latitude, longitude, and altitude. This corresponds to the X, Y and Z locations of the equipment inside the 3D virtual world. The latitude, longitude, and altitude can be specified in geographic (spherical) or projected coordinate system units such that the locations of all entities are specified in the same system. Orientation of a 3D model in a virtual world can be specified through rotation about a specific axis or a combination of axes. By selection of appropriate axes of rotation in the virtual world, the rotations in real and virtual worlds can be correlated to each other. For example, the axis of rotation of sensors placed on equipment in the real-world can be made equivalent to the global axes of rotation in the virtual world as previously described. Thus the rotation values from the server are specified in terms of roll, pitch, and yaw, about the X-, Y-, and Z-axis respectively.

Through the specification of orientation angles in terms of roll, pitch, and yaw, the orientation angles from the real-world can always be correlated to the virtual world regardless of the sensors used. For example, the use of linear encoders to measure the extended lengths of pistons on the server side of an equipment monitoring operation can be modified at the server-side by converting the lengths of cylinder extension to equivalent rotation angles for the boom or stick. In this manner, the same visualization and proximity monitoring-based client can be used with both direct orientation sensors such as accelerometers and indirect approaches such as linear encoders. Thus, insulation of the client visualization and proximity monitoring from the sensors used on the server side ensure scalability and non-specificity.

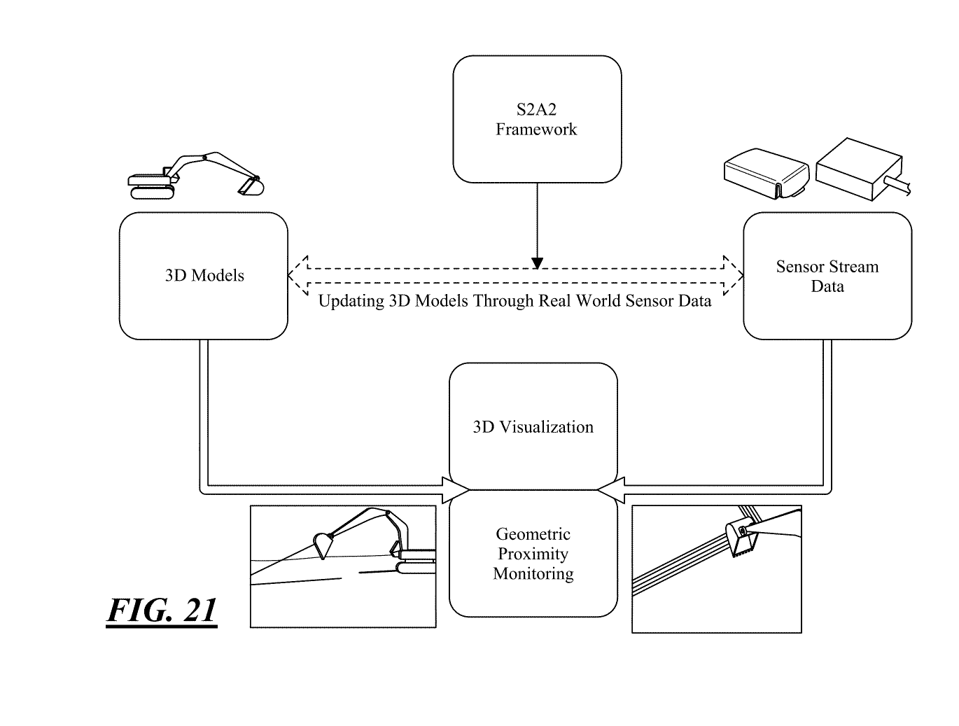

In one embodiment, a framework enables transmission of real-world sensor data into a 3D virtual world. The framework is referred to herein as the sensor stream acquisition allocation (S2A2) framework. The S2A2 framework is designed as an interface to an existing real-time 3D visualization system, SeePlusPlus (previously described) that has been developed for improving safety in excavation operations through monitoring of excavators and providing visual guidance and warnings against impending collisions with buried utilities. The S2A2 framework is a link between articulated 3D equipment models present in the virtual world (SeePlusPlus) and sensor data streams from the real-world. FIG. 21 shows a schematic overview of the proposed equipment monitoring approach through real-time 3D visualization and proximity monitoring. The process of connecting sensor data streams from the real-world to 3D equipment residing in a virtual world depends upon the ability to expose to the user, the available 3D equipment components that can undergo rotation and/or translation. Furthermore, in this embodiment the 3D equipment should exhibit the same parent-child relationship in the virtual world as is evident in the real-world. 3D equipment models used for such monitoring purposes can be built from individual sub-components rather than consisting of a single model that is incapable of movement in its sub-components. This can be implemented in another software tool designed for creating 3D equipment models to assist in monitoring operations. The tool is referred to herein as the virtual equipment builder’ (VEB).

The VEB can be designed as a graphical interface that allows users to load individual equipment components as child (or parent) elements of other components and thus build up a complete equipment model in the process. The complete equipment model can be saved for use in the SeePlusPlus real-time 3D visualization system. The VEB can be designed and developed as an interactive tool that allows users to manipulate the view as well as change the position and/or orientation of components while creating the complete equipment model. SeePlusPlus is the 3D visualization system that can provide users with visual guidance and also can have an associated proximity monitoring and collision detection module. However, for the virtual world in SeePlusPlus to be representative of real-world operations, a user utilizes a method to connect real-world sensor data to equipment components that make up the 3D equipment models. In one embodiment, proximity monitoring in SeePlusPlus can be displayed to the user through three channels. First, numerical shortest distance to collision; second, lines drawn between bucket and utilities; and third, traffic signal colors-based warning showing green, amber and red for varying levels of safety and accident risk.

The connection between server streams and the client can be implemented through socket-based connections. In sensor implementations, data can be transferred from the sensors to a server-side application wirelessly or through a physical connection. The server-side application then converts the raw data to position and/or orientation values. Thus, the server- and client-side applications can run on the same physical machine and the use of socket-based connections ensures that data transfer is application-independent. A successful connection between client and server sides can result in the new server stream being added to the list of available sensors in the S2A2 interface. The interface can also present the list of sub-components that make up the 3D equipment model. The interface can also allocate sensor streams to user defined equipment components. The allocation can be specified through a set of checkboxes that allows users to select what component of the sensor data stream may be used to update the selected equipment component. For example, selection of only translate X, translate Y, and translate Z options of a sensor stream ensures that only its position aspect would be used to update the selected equipment component. In a similar manner, the rotation can also be specified by choosing one or more of roll (rotate X), pitch (rotate Y) and yaw (rotate Z). Once an equipment component has been allocated a sensor stream, its position and/or orientation is updated in real-time as long as the sensor in the real-world is active and transmitting data. Thus the S2A2 interface is designed to work together with the SeePlusPlus real-time 3D visualization application in providing real-world sensor data to update the corresponding 3D equipment models. This helps enable the monitoring of operations and improve safety.

Validation experiments were carried out. The experiments are designed to demonstrate the functioning of the S2A2 framework and the accompanying 3D visualization when used to monitor and track a backhoe, and characterize the extent to which an arbitrary construction operation involving articulated equipment can be visualized in a real-time concurrent 3D virtual world. Through the S2A2 framework, changes in the equipment's articulation are transmitted to a 3D visualization in real-time. This position and orientation data is then used in the visualization to update the location and pose of corresponding dynamic entities. The updated 3D equipment components are then used in real-time proximity analysis to present distance and impending collision information to the operator of the equipment. The backhoe used in these experiments was a Caterpillar 430 E IT. The articulation of the equipment's arm and end-effector was captured through a series of orientation sensors placed along its boom, stick and bucket. The orientation sensors used in the experiment were XSens MTw. Bluetooth wireless technology was used to transfer pose data from individual sensors to the device running the 3D visualization. The accuracy of the sensors and their calibration is measured through the proximity monitoring framework that uses the pose updates as input.

Through the 3D visualization and proximity analysis, the experiments demonstrate equipment monitoring in the following manner: in the first experiment, distances computed in the virtual world are compared to those in the real-world. In the second experiment, the effect of audio and visual warnings on an operator's performance is investigated. The experiment details and results obtained are described below.

The focus of a first experiment was on capturing and representing the real-world equipment articulation in a 3D virtual environment. Hence, the position aspect of the equipment was discounted as the device was assumed to be stationary. Through the proximity monitoring framework, the distance between the equipment's end-effector (bucket in this case) and the ground surface on which the equipment was resting, was monitored at all times. If the equipment's articulation in the 3D virtual environment was an accurate representation of the real-world, the distance between the end-effector and ground surface would be identical (after accounting for sensor-based inaccuracies) in both the real and virtual worlds. During the test, the equipment's boom, stick, and bucket was manipulated by the operator similar to regular operations. As the validation required distance values from both the virtual and real-worlds, the operator was instructed to stop motion of the equipment's arm whenever a distance measurement was to be made in the real-world. After the equipment had come to a complete halt, the distance between the end-effector (bucket) and the ground surface beneath it was measured using a measuring tape. This process was repeated for changeable configurations of the boom, stick, and bucket. In total, fifteen distance measurements were made in the real-world. Corresponding distances displayed by the proximity monitoring framework in the virtual world were also recorded simultaneously. The values obtained from real and virtual world measurements are shown in Table 4 below.

TABLE 4

| Iteration | Distance in Real | Distance in Virtual | Real World − Virtual |
|---|---|---|---|
| No. | World (meters) | World (meters) | World (meters) |
| 1 | 3.07 | 3.12 | 0.05 |
| 2 | 1.54 | 1.52 | −0.02 |
| 3 | 1.14 | 1.16 | 0.02 |
| 4 | 0.63 | 0.66 | 0.03 |
| 5 | 0.00 | 0.17 | 0.17 |
| 6 | 0.66 | 0.68 | 0.02 |
| 7 | 1.62 | 1.62 | 0.00 |
| 8 | 2.18 | 2.08 | −0.10 |
| 9 | 2.48 | 2.39 | −0.09 |
| 10 | 2.84 | 2.71 | −0.13 |
| 11 | 1.82 | 1.87 | 0.05 |
| 12 | 0.99 | 0.99 | 0.00 |
| 13 | 0.61 | 0.67 | 0.06 |
| 14 | 2.66 | 2.74 | 0.08 |
| 15 | 2.54 | 2.59 | 0.05 |

A second experiment was designed to test the latency of the S2A2 framework and effectiveness of the warnings provided by the 3D visualization and proximity monitoring framework. The setup was similar to that in the first experiment, where the equipment was assumed to be stationary and only orientation coordinates were used in the analysis. Unlike in the first experiment, a tolerance check was introduced to warn the operator as soon as a preset safety threshold was breached. For the purpose of the test, distances of 2.0, 2.5 and 3.0 m were set as the safety threshold level between the end-effector and the ground surface. The proximity monitoring framework in this experiment was thus designed to warn the operator when the end-effector comes within the preset safety threshold distance to the ground surface. Once again the test was carried out through multiple iterations with changeable articulation of the boom, stick, and bucket. The operator was instructed to halt the motion of the equipment as soon as an audio-visual warning was provided. Once the equipment was stopped, the distance between the end-effector and the ground surface was recorded. This process was repeated ten times and results from each iteration along with the distance by which the operator had penetrated the preset buffers (2.0, 2.5, 3.0 m) are presented in Table 5. The significance of the results and their interpretation is presented below.

TABLE 5

| | | Distance | Penetration | Operating |
|---|---|---|---|---|
| | Buffer | from the | into | Speed (L = |
| Iteration | Depth | ground surface | safety buffer | Low, H = High, |
| No. | (meters) | (meters) | (meters) | V = Very High) |
| 1 | 2.00 | 1.87 | 0.13 | L |
| 2 | 2.00 | 1.01 | 0.99 | H |
| 3 | 2.00 | 0.67 | 1.33 | V |
| 4 | 3.00 | 2.74 | 0.26 | L |
| 5 | 3.00 | 2.59 | 0.41 | H |
| 6 | 2.50 | 2.22 | 0.28 | L |
| 7 | 2.50 | 1.79 | 1.11 | H |
| 8 | 2.50 | 0.80 | 1.70 | V |
| 9 | 2.50 | 1.39 | 1.11 | H |
| 10 | 2.50 | 1.54 | 0.96 | H |
| 11 | 2.50 | 1.98 | 0.52 | L |
| 12 | 2.50 | 2.12 | 0.38 | L |
| 13 | 2.50 | 1.94 | 0.56 | L |
| 14 | 2.50 | 2.07 | 0.43 | L |
| 15 | 2.50 | 1.62 | 0.88 | H |

In the first experiment, the difference between end-effector to ground surface distance in real and virtual worlds can be attributed to the following factors. The first and most significant factor relates to the ground surface slope. The experiment was carried out in an indoor facility. The floor of this facility had a slight slope/gradient to it designed to allow water drainage. However, in the virtual world, ground surface was modeled as a perfectly flat surface due to non availability of the indoor elevation data for the experiment site. Thus, a positive or negative slope for the ground surface in the real-world would result in vertical distance values (from bucket teeth to ground surface) that are less or greater than the corresponding values measured to a flat surface in the virtual world. Second is the geometric difference between the bucket in the real and virtual worlds. The bucket of the backhoe was modeled from a pre-existing 3D model and thus resulted in unintended dimensional variances between the bucket teeth in the real and virtual world objects. The distance in the first experiment was measured as the vertical separation distance between the bucket teeth and ground surface. Hence, dimensional equivalence is stated as a key requirement for accurate monitoring of equipment on jobsites. The third source of error is based on the accuracy of angles measured and reported by the orientation sensors used in the experiment. The static accuracy of the MTw sensors used in the experiment is stated as being 0.5 degrees (XSens 2012). Thus, for a boom length of 2.75 m as in the case of the Caterpillar 430 E IT, a 0.5 degrees error results in a vertical deviation of 0.09 m. The combination of these factors is attributed to the difference between real and virtual world values for distance between the backhoe bucket and ground surface, observed in the first experiment. The mean separation distance error with the standard deviation (shown in Table 4) is 0.06±0.05 m.

The second experiment was designed to test the effect of audio and visual warnings on an operator when a preset safety threshold was breached by the end-effector. The experiment used safety thresholds of 2.0, 2.5 and 3.0 m. For each of the safety thresholds, the operator manipulated the equipment at varying speeds, categorized in Table 5 as low, high, and very high. Low corresponds to the angular speed when a bucket would be in close proximity to a surrounding object or when working in a narrow or confined space. High and very high correspond to the typical angular speed of the bucket that would be observed during the course of regular excavation operations. The safety threshold value was changed through the course of the experiment to ensure that the operator was responding to the warnings and not the learning-effect of the same threshold value. Different depth values also provided the opportunity to analyze the effect of larger safety buffers over smaller values. The goal of the safety buffer is to provide a warning to the operator with sufficient reaction time to bring the equipment to a halt before the end-effector can come in physical contact with an object that may be occluded such as buried utilities covered by the soil. The effectiveness of a safety buffer is analyzed by computing the magnitude by which the buffer was breached by the bucket. Table 6 shows the list of values by which the bucket breached the preset safety threshold (expressed as a percentage of the buffer depth) after the operator was provided with warnings. In Table 6, it can be observed that the magnitude by which the safety buffer was breached did not vary significantly when the safety buffer depth was changed between 2.0, 2.5 and 3.0 m. For example, at very high operating speed, the safety buffer was breached by 67% for a 2.0 m buffer and 68% for a 3.0 m.

TABLE 6

| | | % Safety |
|---|---|---|
| Buffer Depth | Operating Speed (L = Low, | Buffer |
| (meters) | H = High, V = Very High) | Breached |
| 2 | L | 7 |
| 2 | H | 50 |
| 2 | V | 67 |
| 3 | L | 9 |
| 3 | H | 14 |
| 2.5 | L | 11 |
| 2.5 | H | 44 |
| 2.5 | V | 68 |
| 2.5 | H | 44 |
| 2.5 | H | 38 |
| 2.5 | L | 21 |
| 2.5 | L | 15 |
| 2.5 | L | 22 |
| 2.5 | L | 17 |
| 2.5 | H | 35 |

The average percentage safety buffer penetration for L, H, and V operating speeds was found to be 15%, 38%, and 68% respectively. Thus it can be seen that the safety buffer depth depends on the operating speed of the equipment and the specific operating style of a given operator.

In one embodiment, the method and system of estimating 3D pose of an articulated machine as disclosed in U.S. Provisional Patent Application No. 61/914,999 filed Dec. 12, 2013 can be employed in the method and system of monitoring proximity of objects detailed in this description. The entire contents of Provisional Patent Application No. 61/914,999 are hereby incorporated by reference. Somewhat briefly here, the method and system of estimating 3D pose involves the use of one or more marker(s) and one or more image-capturing device(s) aimed at the marker(s). A registration algorithm framework—such as homography-from-detection or homography-from-tracking—is then employed to determine the 3D pose of the image-capturing device(s). Once determined, the 3D pose of the marker(s) is determined by using forward kinematic calculations. With this embodiment, movement of a piece of construction equipment like an excavator can be simulated via the marker(s) and image-capturing device(s) rather than position and orientation sensors.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of monitoring proximity of objects at a construction jobsite via three-dimensional virtuality in real-time, the method comprising the steps of:
a) simulating movement of a dynamic object of the construction jobsite in a three-dimensional virtual representation of the construction jobsite;
b) simulating a second object of the construction jobsite in the three-dimensional virtual representation of the construction jobsite;
c) determining a geometric proximity between the simulated dynamic object of the construction jobsite and the simulated second object of the construction jobsite; and
d) outputting a notification based upon the geometric proximity determination of step c).

2. The method of claim 1 wherein step a) comprises receiving movement data from at least one device of the dynamic object in order to simulate movement of the dynamic object in the three-dimensional virtual representation of the construction jobsite.

3. The method of claim 2 wherein the at least one device is a position sensor, an orientation sensor, a marker and image-capturing device, or a combination of these.

4. The method of claim 1 wherein the second object of the construction jobsite is a static object, and wherein step b) uses georeferencing to simulate the second object.

5. The method of claim 1 wherein steps a) and b) further comprise using geographical information system data, computer-aided design data, or both geographical information system data and computer-aided design data in the simulation.

6. The method of claim 1 wherein step a) further comprises using user input from human interface devices in order to simulate the dynamic object of the construction jobsite.

7. The method of claim 1 wherein the geometric proximity of step c) is a distance between the simulated dynamic object and the simulated second object, is an overlap between the simulated dynamic object and the simulated second object indicative of a collision between the dynamic object and the second object, or is both.

8. The method of claim 1 wherein step d) comprises outputting an audio notification, outputting a visual notification, or outputting both an audio and visual notification.

9. The method of claim 1 further comprising the step of simulating a terrain of the construction jobsite in the three-dimensional virtual representation of the construction jobsite.

10. The method of claim 1 further comprising the steps of determining whether a pre-determined safety distance threshold between the simulated dynamic object and the simulated second object has been breached, and outputting a notification based thereupon.

11. The method of claim 1 wherein the dynamic object is a piece of construction equipment, and the second object is a buried utility.

12. The method of claim 1 further comprising the step of visually displaying the three-dimensional virtual representation of the construction jobsite with the simulated dynamic object and with the simulated second object.

13. A computer readable medium comprising a non-transient data storage device having stored thereon instructions that carry out the method of claim 1.

14. A system for monitoring proximity of objects at a construction jobsite via three-dimensional virtuality in real-time, the system comprising:
a computer readable medium comprising a non-transient data storage device having instructions thereon for performing the steps of:
i) simulating a terrain of the construction jobsite in a three-dimensional virtual representation of the construction jobsite;
ii) simulating movement of a dynamic object of the construction jobsite with respect to the simulated terrain in the three-dimensional virtual representation of the construction jobsite, the simulation comprising receiving movement data from at least one device of the dynamic object;
iii) simulating a static object of the construction jobsite with respect to the simulated terrain in the three-dimensional virtual representation of the construction jobsite, the simulation involving georeferencing;
iv) determining a geometric proximity between the simulated dynamic object of the construction jobsite and the simulated static object of the construction jobsite;
v) displaying the three-dimensional virtual representation of the construction jobsite with the simulated terrain, with the simulated dynamic object, and with the simulated static object; and
vi) outputting a notification based upon the geometric proximity determination.

15. The system of claim 14 wherein the at least one device of the dynamic object is a position sensor, an orientation sensor, a marker and image-capturing device, or a combination of these.

16. The system of claim 14 further comprising using geographical information system data, computer-aided design data, or both geographical information system data and computer-aided design data in the dynamic and static object simulations.

17. The system of claim 14 further comprising using user input from human interface devices in the dynamic object simulation.

18. The system of claim 14 wherein the geometric proximity is a distance between the simulated dynamic object and the simulated static object, is an overlap between the simulated dynamic object and the simulated static object indicative of a collision between the dynamic object and the static object, or is both.

19. The system of claim 14 wherein the outputted notification is an audio notification, a visual notification, or it both an audio and visual notification.
